(19) United States
(12) Patent Application Publication
(10) Pub. No.: US 2026/0093753 A1
(43) Pub. Date: Apr. 2, 2026

(54) SYSTEMS AND METHODS FOR IDENTIFYING AND PROVIDING CONTENT RELATED TO AN UNSTRUCTURED MEDIA CONTENT ITEM

(71) Applicant: Adeia Guides Inc., San Jose, CA (US)

(72) Inventors: Dhananjay Lal, Englewood, CO (US); Reda Harb, Saint Petersburg, FL (US)

(21) Appl. No.: 18/901,328

(22) Filed: Sep. 30, 2024

(51) Int. Cl. G06F 16/783; G06Q 30/0241; G06Q 50/00; G06T 5/77; G06T 7/10

(52) U.S. Cl. CPC G06F 16/783; G06Q 10/40; G06Q 30/0241; G06T 5/77; G06T 7/10

(57) ABSTRACT

Systems and methods are provided for accessing an unstructured media content item. A first fingerprint for at least a portion of the unstructured media content item is generated, and a database storing a plurality of fingerprints is accessed. Each of the plurality of fingerprints corresponds to at least a portion of a respective structured media content item of a plurality of structured media content items. The first fingerprint is determined to correspond to a second fingerprint from the plurality of fingerprints stored at the database, and a structured media content item corresponding to the second fingerprint is identified. Data related to the structured media content item may be retrieved, and an action may be caused to be performed based on the retrieved data.

### BACKGROUND

The present disclosure is directed to generating fingerprint metadata for unstructured media, such as short-form content.

### SUMMARY

Short-form content, such as short-form video content, is unstructured media that can be quickly consumed. Often, short-form content is designed to capture an audience's attention with visually engaging, focused messages. Short-form content exists generally on social media platforms with scrollable interfaces, such as TikTok®, Instagram, Snapchat®, Facebook®, and YouTube® Shorts, among others. Short-term content is typically generated in an informal setting by users of such social media platforms. In contrast, structured media, such as long-form content, may include more advanced narratives than short-form media. For example, “long-form content” may refer to movies, TV shows, YouTube videos, podcasts, or other media that is created in formal settings. Long-form content differs from short-form content mainly because long-form content is generally structured, and short-form content is generally unstructured.

Unstructured data refers to information that is not arranged according to a preset data model or schema. Short-form content, such as user-generated content (UGC), is often unstructured in that the metadata for the short-form content is very limited. The short-form content metadata may comprise of a combination of user-provided information such as likes, comments, and reposts, and analysis by a platform. For example, the platform that is hosting the short-form content, such as a social media platform, may use an AI engine to identify genre(s) for the short-term content solely so that the short-term content may be shown in a search related to the genre on the platform. However, short-form content metadata generally do not have detailed attributes generated on a scene-by-scene basis. Long-form content may have these detailed attributes in its metadata. For example, long-form content may include sophisticated and structured metadata such as information related to a title, release date, genre, runtime, director, cast, synopsis, summary, language, subtitles, audio tracks, content ratings, awards, commentary, video fingerprinting, 3D animation, or other identifying characteristics of the long-form content that may be used to identify certain portions of the long-form content.

Short-form content creators often include portions of long-form content in their UGC. For example, a user may create a short-form video that includes a short video clip of the movie “Spider-Man” (and/or an audio clip from the movie “Spider-Man”) as well as video and/or audio of themselves as an overlay or voiceover of the short clip of “Spider-Man,” such as if the user is an influencer to show their reactions to the scene of “Spider-Man,” and/or to help avoid certain copyright concerns in some jurisdictions. To prevent triggering copyright algorithms, the short-form video may be configured to purposely (simply out of laziness or ignorance, or inadvertently) lack metadata regarding such long-form content, and/or the user may have omitted metadata regarding the long-form content when publishing such short-form video in their social network post. On the other hand, a viewer of the short-form video may nonetheless like to be provided with information about, and engage with, the long-form content of “Spider-Man” depicted in the short-form video, but this may be difficult or not readily available due to the lack of structured metadata associated with the short-form video.

In one approach, short-form content and long-form content may undergo video or audio fingerprinting, based on perceptual characteristics, such as frame patterns, colors, and audio features, instead of being based on its exact binary data, and a hash is created, and content with matching or similar perceptual hash values can be identified as similar content. However, such approach may not be sufficient in the aforementioned circumstance where a clip of long-form content, such as the “Spider-Man” movie, is combined with other content, such as a video of an influencer reacting to the scene, or a voiceover introduced by the influencer over the “Spider-Man” scene. For example, such alterations introduced by the influencer to the scene of “Spider-Man” may cause a fingerprint or hash calculated for the short-form video to be sufficiently different from hashes or fingerprints of the long-form content of “Spider-Man,” such that the short-form content is not able to be determined to match the long-form content.

Due to the above-described lack of tools in these approaches for efficiently identifying, generating, or associating metadata with short-form content, such approaches fail to cause actions to be performed (e.g., fail to enable user engagement with matching long-form content) based on identifying a correspondence between a portion of a short-form media content item and a long-form content item.

To help address the limitations and problems of these and other approaches, systems, methods, and apparatuses are provided herein for providing options to engage with long-form content referenced by short-form content. Specifically, systems, methods, and apparatuses provided disclosed herein provide for accessing an unstructured media content item. For example, the system may access a short-form media content item from a short-form content platform. The disclosed system further describes generating a first fingerprint for at least a portion of the unstructured media content item. For example, the system may identify a salient region of the short-form media content item to use as input into a fingerprinting engine to generate a video fingerprint of the salient region of the short-form content item. The disclosed system further describes accessing a database storing a plurality of fingerprints, each of the plurality of fingerprints corresponding to at least a portion of a respective structured media content item of a plurality of structured media content items. For example, the system may compare the video fingerprint of the salient region of the short-form media content item to one or more fingerprints stored at a fingerprint database from a media-streaming platform, e.g., storing video fingerprints of scenes from movies or shows on the media-streaming platform.

The disclosed system may further determine that the first fingerprint corresponds to a second fingerprint from the plurality of fingerprints stored at the database. For example, the system may determine that the video fingerprint of the salient region of the short-form media content item matches a video fingerprint from the fingerprint database of a scene from a movie or show on a media-streaming platform. The disclosed system further identifies a structured media content item from the plurality of structured media content items that corresponds to the second fingerprint. For example, the system may identify the movie or show that corresponds to the matched video fingerprint from the fingerprint database. The disclosed system further retrieves data related to the structured media content item. For example, the system may retrieve metadata, and cause performance of an action (e.g., while the short-form content is being played, or after the short-form content is played) based on the retrieved data. For example, the action may comprise providing for output media guidance options, content clips, links, character information, user-created short-form content, images, audio, video, extended reality (XR) content, streaming information, viewing options, viewing schedules, trailers, movie posters, behind-the-scenes clips, or other types of collateral assets related to the movie or show, and/or any other suitable content related to the identified long-form content.

Such aspects enable efficiently identifying long-from media content that corresponds to a portion of short-form, unstructured media content. For example, even if the short-form, unstructured media content has content (e.g., a video of an influencer reacting to a clip of a movie that is also included in the unstructured media content), segmentation and masking and/or scene boundary identification techniques may be employed to isolate the salient portions of the short-form, unstructured media content for comparison to a corpus of fingerprints of long-form content.

In some embodiments, the provided systems and methods may extract salient portions of short-form content that correspond to long-form content, and discard the portions introduced by the user/influencer, to better match short-form clips to long-form clips, to enable user engagement options to be provided that accurately reflect the clip of the long-form content in the short-form video. Such methods may systematically “slice and dice” the UGC and generate fingerprints. These fingerprints are then compared to a long-form content catalog or library. The resulting matches may be further presented in a manner that makes them available to the viewer, whether in the present (such as with video on demand, or VoD) or in the future (such as with DVR recording, by setting a reminder for an upcoming broadcast or future program using the provider's EPG metadata), including highlighting listings in an EPG that were encountered on social media (e.g., scene of a movie associated with the listing was consumed on TikTok, etc.). Additionally, the Pay TV or Over-The-Top search engine can also utilize such fingerprints to further personalize search results for users or even disambiguate queries.

In some embodiments, the system may divide a short-form media content item into several fragments based on scene boundaries that are individually available for fingerprint matching or further subdivision. In some embodiments, the system may detect highly salient images in a short-form content and convert them into fingerprints.

In some embodiments, the system may present a user with multiple options for viewing after content is matched/identified including consuming via various video services (e.g., SVOD, AVOD, TVOD, etc.), setting reminders, and setting DVR recording(s), etc. In some embodiments, the recommendation of video services to use for content consumption is based on available user subscription data to various video services (e.g., OTT services), apps that are available (installed) on a user device, etc.

In some embodiments, the system may allow video services to utilize such data to personalize search and disambiguate text or voice queries (e.g., use the generated metadata to interpret and respond to a query of “show me the movie in the TikTok video with the dog”). In some embodiments, fingerprint IDs (e.g., generated for videos, such as unstructured videos, accessed by a user via a social network platform) are associated with users and used as another corpus (fingerprint corpus). For example, if the system determines that a short-form video that was accessed shows a talking dog (e.g., a meme) alongside a clip from long-form content, the system may generate a fingerprint of the short-form video (e.g., based on the clip of the movie “Cars”)) and match it to the long-form video. In some embodiments, the system may generate additional metadata describing characteristics of the short-form video. For example, the system may generate additional metadata about the talking dog from the short-form video or any other characteristic of the short-form video, and associate such metadata with the short-form content and/or the long-form content. In some embodiments, the generated additional metadata may be used by the system to disambiguate text or voice queries. For example, based on receiving a query “What's the name of the movie with the talking dog,” the system may use such metadata to determine the user is referencing the movie “Cars,” based on the user's past interaction with the short-form video featuring the movie clip from “Cars” as well as the talking dog. Such query may be otherwise generic and not likely to yield useful results, if not for the previous context of the short-form video accessed by the user and fingerprinted to determine an association with certain long-form content. In some embodiments, intent determination in a voice search system can use this as additional metadata to attempt to determine what the user is asking for. In some embodiments, the system may perform an action on the identified media content item based on factors such as the viewer's subscriptions, prompts to rent or purchase the content, subscribe to a content source that offers the content, form a group watch to watch the content with others. In some embodiments, if the content is available for immediate viewing, then the fingerprint is used to retrieve the content for playback in full-screen mode, Picture-in-Picture (PiP), or any other suitable arrangement.

In some embodiments, the first fingerprint is generated based at least in part on receiving an input from a second user of the social network platform requesting that one or more actions be taken regarding the structured media content item that corresponds to the unstructured media content item.

In some embodiments, based on identifying the structured media content item, from the plurality of structured media content items, that corresponds to the second fingerprint, the disclosed systems and methods may associate metadata related to the retrieved data with the unstructured media content item prior to receiving input from a second user of the social network platform to access the unstructured media content item. For example, the system may associate metadata related to the retrieved data with a popular or trending video prior to receiving input from a second user to access the popular or trending video of the social network platform.

In some embodiments, the disclosed systems and methods may determine the at least a portion of the unstructured media content item comprises a first video being simultaneously played with (or within) a second video, as part of the social network post, wherein generating the first fingerprint is based on the first video and is not based on the second video.

In some embodiments, the second video overlaps and is played simultaneously with a portion of the first video, or the second video is played at a different time than the first video within the unstructured media content item and does not overlap a portion of the first video.

In some embodiments, the first video comprises a background of the unstructured media content item, and the second video comprises a foreground of the unstructured media content item. In some embodiments, the second video comprises an object occluding the first video, and the disclosed systems and methods further comprise: determining that the first video is associated with a saliency value above a threshold; modifying the at least a portion of the unstructured media content item by segmenting and masking out the second video including the object; and performing in-painting at a portion of the first video previously occluded by the object of the second video; and generating the first fingerprint based on the modified at least a portion of the unstructured media content item comprising the salient first video having the in-painted portion. In some embodiments, the system may generate a saliency map of an unstructured media content item, to find the most salient regions of image(s) or video(s). The salience map may assign numerical scores or weights to each pixel that represents the relative importance of each element to the model's output (e.g., a fingerprint for accessed short-form content). In some embodiments, based on the computation of saliency and determination of a highly salient region for generating the fingerprint, and only utilizing a fingerprint of a portion of the image of video (e.g., of the short-form video), processing resources and/or computing resources may be conserved and employed more efficiently, to speed up processing and even matching of fingerprints. In some embodiments, a saliency value can influence the fingerprinting process, e.g., a video with a relatively large number of salient regions in an image (e.g., above a threshold amount) might not require that processing a lot of frames to generate the fingerprint. In some embodiments, if the system receives feedback or determines that a fingerprint for a short-form video was not able to be matched to long-form video, based on the fingerprints of the salient regions, the system may perform another fingerprint generation process to capture more regions or even fingerprint the whole frame (e.g., not including what was added by the influencer or content creator to the short-form video).

In some embodiments, the object is a depiction of the first user of the social network platform. In some embodiments, causing performance of the action comprises causing the social network platform to output an advertisement for the structured media content item, based on the retrieved data. In some embodiments, causing performance of the action comprises redirecting a user from a social network platform, at which the unstructured media content item is accessed by the user, to a second content platform, which performs the action based on the retrieved data, wherein the user is associated with a user profile with the second content platform that is linked to a user profile of the user with the social network platform.

In some embodiments, causing performance of the action further comprises providing, based on the retrieved data, a selectable option to access the structured media content item, and wherein the redirecting is performed in response to receiving selection of the selectable option.

In some embodiments, the disclosed systems and methods further comprise determining that a user of a social network platform, at which the unstructured media content item is accessed by the user, is accessing a second content platform, and providing a reply to a query received from the user via the second content platform, wherein the query is disambiguated based at least in part on the retrieved data, and wherein the retrieved data comprises metadata that is associated with the unstructured media content item based on the first fingerprint and the second fingerprint.

In some embodiments, prior to generating the first fingerprint, the unstructured media content item is not associated with metadata identifying a title of a structured media content item that comprises the at least a portion of the unstructured media content item. In some embodiments, the disclosed systems and methods further comprise causing performance of the action of generating for display, based on the retrieved data, a recommendation to play the structured media content item or store the structured media content item.

In some embodiments, the disclosed systems and methods further comprise determining that that a user of a social network platform, at which the unstructured media content item is accessed by the user, is not subscribed to a second content platform enabling access to the structured media content item, and causing performance of the action of generating for display, based on the retrieved data, an option to enable the user to subscribe to the second content platform to access the structured media content item.

In some embodiments, the plurality of structured media content items comprises at least one movie or television show, and the plurality of fingerprints stored in the database comprise fingerprints for portions of the at least one movie or television show if it has at least a threshold level of popularity and do not comprise fingerprints for portions of the at least one movie or television show if it does not have at least the threshold level of popularity.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein may be better understood by referring to the following description in conjunction with the accompanying drawings in which like reference numerals indicate functionally similar elements, of which:

FIG. 1 shows an illustrative diagram of a content analysis system for identifying a structured media content item corresponding to at least a portion of an unstructured media content item, in accordance with some embodiments of this disclosure.

FIG. 2 shows an illustrative example of providing a matched structured media content item corresponding to an unstructured media content item, in accordance with some embodiments of this disclosure.

FIG. 3 shows a system diagram for detecting scene boundaries of an unstructured media content item, generating a fingerprint of an identified scene of the unstructured media content item, matching the fingerprint of the identified scene to a fingerprint of a structured media content item, and providing the structured media content item, in accordance with some embodiments of this disclosure.

FIG. 4 is a flow diagram of an illustrative process for communication between a short-form content platform and a long-form content platform, in accordance with some embodiments of this disclosure.

FIG. 5 is a flow diagram of an illustrative process for fingerprinting a content item using a content analysis module, in accordance with some embodiments of this disclosure.

FIG. 6 is a flow diagram of an illustrative process of identifying a matched media content item in a TV schedule based on a viewing history, authorizing access between a short-form content platform to a linear TV provider, and recording the matched media content item from the linear TV provider using a recording service, in accordance with some embodiments of this disclosure.

FIG. 7 is a flow diagram of an illustrative process of matching a short-form content item to a long-form content item using the content analysis module and presenting the viewing availabilities of the matched content to a user, in accordance with some embodiments of this disclosure.

FIGS. 8-9 show illustrative devices and systems for identifying a structured media content item corresponding to at least a portion of an unstructured media content item, in accordance with some embodiments of this disclosure.

FIG. 10 is a flowchart of a detailed illustrative process for identifying a structured media content item corresponding to at least a portion of an unstructured media content item, in accordance with some embodiments of this disclosure.

### DETAILED DESCRIPTION

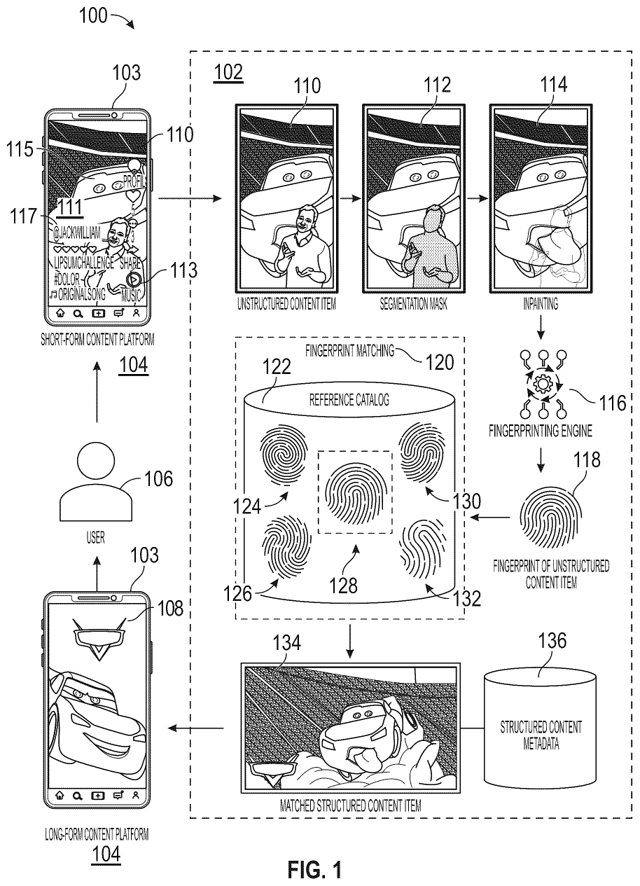

FIG. 1 shows an illustrative diagram of content analysis system 100 identifying structured media content item 108 corresponding to at least a portion of unstructured media content item 110, in accordance with some embodiments of this disclosure. In some embodiments, content system 100 may be incorporated into short-form content platform 104 (e.g., a social network) or long-form content platform 105 (e.g., a streaming platform providing access to long-form live or on-demand media assets, such as, for example, live television, serial content, movies, or any other suitable long-form content), or content system 100 may be distinct from short-form content platform 104 and long-form content platform 105. For example, content analysis module 102 of content system 100 may be co-located with short-form content platform 104 or long-form content platform 105, or content analysis module 102 may be an intermediary or third-party service.

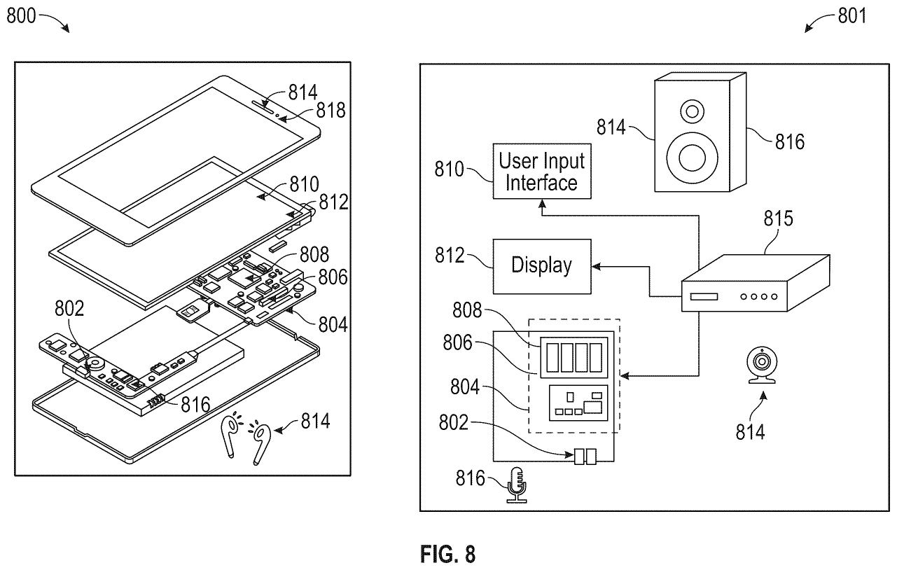

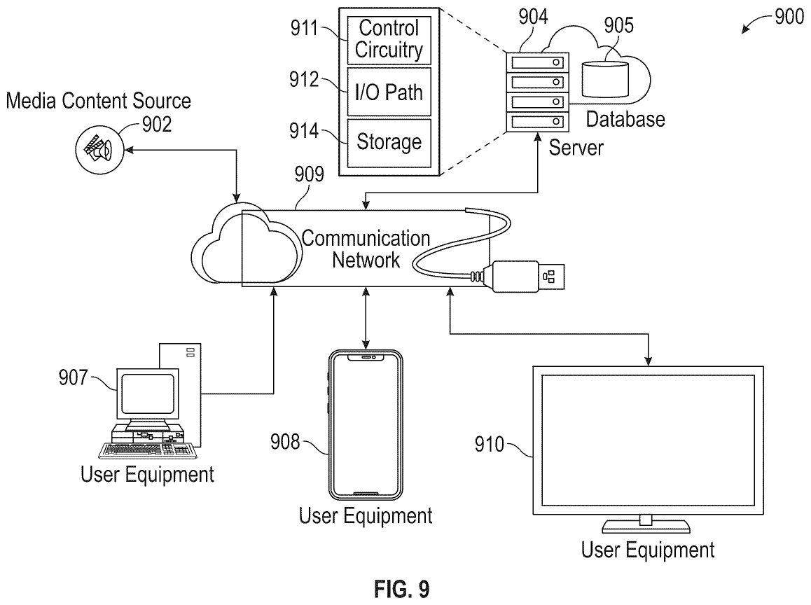

Content analysis system 100 may be executed at least in part at one or more client devices (e.g., device 103 of FIG. 1, which may correspond to device 800, 801 of FIG. 8) and/or at one or more remote servers (e.g., media content source 902 and/or server 904 of FIG. 9) and/or databases, and/or at any other suitable computing device(s). Content analysis system 100 may be configured to perform the functionalities (or one or more portions thereof) described herein. In some embodiments, Content analysis system 100 may be incorporated as part of any suitable application or software. For example, hybrid system 100 may comprise or be implemented in conjunction with one or more extended XR applications; content delivery network (CDN) applications; video game applications, one or more image or video capturing and/or editing applications; one or more image, video and/or textual acquisition, recognition and/or processing applications; one or more content creation applications; one or more machine learning models or artificial intelligence models; one or more streaming media applications; or any other suitable application(s) or any combination thereof; and/or may comprise or employ any suitable number of displays, sensors, or devices such as those described in FIGS. 1-10, or any other suitable software and/or hardware components; or any combination thereof.

“XR” may be understood as virtual reality (VR), augmented reality (AR) or mixed reality (MR) technologies, or any suitable combination thereof. VR systems may project images to generate a three-dimensional environment to fully immerse (e.g., giving the user a sense of being in an environment) or partially immerse (e.g., giving the user the sense of looking at an environment) users in a three-dimensional, computer-generated environment. Such environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with or are overlaid on the real world.

As shown in FIG. 1, a user 106 may be accessing short-form content platform 104 by way of device 103. In some embodiments, device 103 may be, for example, a headset; a mobile device such as, for example, a smartphone or tablet; a video game console; a laptop computer; a personal computer; a desktop computer; a smart television; a smart watch or wearable device; smart glasses; an XR head-mounted display (HMD); a stereoscopic display; a wearable camera; XR glasses; XR goggles; a near-eye display device; or any other suitable user equipment or device capable of connecting to the Internet or other suitable network; or any combination thereof.

Content analysis system 100 may identify unstructured media content item 110 being presented (or likely to be presented, e.g., in a user's newsfeed, or matching a user's preferences and likely to be selected or searched for in short-form content platform 104) via short-form content platform 104 at device 103. For example, user 106 may be viewing a short-form content such as a video short on a user device. Short-form content platform 104 may be a social media platform, a video sharing platform, a communication platform, a marketplace platform, a content sharing platform, a videogame platform, any other type of platform storing or providing access to unstructured media content items, or any suitable combination thereof. Short-form content platform 104 may be hosted on a server and accessed by a user device 103 to display content items from the short-form content platform on user device 103 to user 106. For example, the server may transmit data to user device 103 to cause user device 103 to display or output short-form video and/or audio content.

In some embodiments, unstructured media content item 110 may be a short-form video included in social media post 111 by a user associated with user profile 117 with the short-form content platform 104. In some embodiments, unstructured media content item 100 may be user-generated content (UGC), such as content edited and created by a user, such as the user depicted in portion 113, via short-form content platform 104; a video short; an audio short; an audiovisual short; content having a duration below a threshold duration and/or below a threshold ratio in relation to its corresponding long-form content; or any type of media that lacks (or includes minimal) descriptive metadata, insufficient to identify a long-form media content item of which an image, text, video and/or audio portion is present in the short-form content.

Unstructured media content item 110 may include a portion 113 and portion 115. Portion 115 may comprise a video, image, or audio clip (e.g., a 10-second clip) of long-form content (e.g., the movie “Cars”), and portion 113 may comprise one or more of an image portion, audio clip, text portion, video clip, or other content comprising a reaction, commentary, or other observation (e.g., a humorous or interesting comment relevant to popular culture) related to portion 115. For example, in FIG. 1, portion 113 may comprise an image of a user, e.g., associated with user profile 117 on the social media platform, providing commentary, or any other suitable object and/or audio that may be viewed as a reaction or response to the long-form content. Portion 113 may be simultaneously provided for output with (and/or provided for output after and/or before) the output of portion 115 in the unstructured media content item 110 of social media post 111. For example, portions 113 and 115 may be videos playing side by side, portion 113 may be overlaid on or otherwise overlap the output of portion 115, portion 115 may be overlaid on portion 113, a duet arrangement may be employed, one of portion 113 or 115 may be in the foreground while the other is in the background, a picture-in-picture arrangement may be employed (e.g., portion 113 may appear in a small video screen on top of or adjacent to or otherwise within the same social media post as portion 115), and/or any other suitable output arrangement may be employed.

Content analysis module 102 of content analysis system 100 may perform processing to identify long-form content that unstructured media content item 110 contains at least portion of. In some embodiments, such processing may be performed before, while, or after unstructured media content item 110 is accessed by user 106. In some embodiments, such processing may be performed based on user preferences (e.g., indicating an interest in unstructured media content item 110) or based on user input, e.g., user interface input received via a display, microphone, camera, or other suitable sensor, such as, for example, selection of an option to identify long-form content contained in unstructured media content item 110, or an explicit command of “Find the movie this clip is from,” “Record this show.” or any other suitable command.

In some embodiments, content analysis module 102 of content analysis system 100 may determine one or more types of content in unstructured media content item 110. For example, content analysis system 100 may determine unstructured media content item 110 comprises an image or video, and may perform visual processing on the image or video, e.g., image segmentation (e.g., semantic segmentation and/or instance segmentation) on one or more portions of unstructured media content item 110 to identify, localize, distinguish, and/or extract objects, and/or different types or classes of objects, or portions thereof. For example, such segmentation techniques may include determining which pixels in the image belong to a particular object (and/or which pixels belong to portion 113 and which pixels belong to portion 115). For example, segmentation of a foreground and a background of the video feed may be performed, and/or content analysis 100 may identify a shape of, and/or boundaries (e.g., edges, shapes, outline, border) between portion 113 and 115.

Any suitable number or types of techniques may be used to perform such segmentation, such as, for example: machine learning, computer vision, object recognition, pattern recognition, facial recognition, image processing, image segmentation, edge detection, color pattern recognition, partial linear filtering regression algorithms, and/or neural network pattern recognition, or any other suitable technique, or any combination thereof. In some embodiments, the system may identify objects by extracting one or more features for a particular object and comparing the extracted features to those stored locally and/or at a database or server storing features of objects and corresponding classifications of known objects. In some embodiments, the system may extract and analyze text from unstructured media content item 110 using any suitable technique, e.g., segmentation, natural language processing, and/or natural language understanding. In some embodiments, to identify portion 113 and portion 115 in unstructured media content item 110, content analysis module 102 may determine that portion 113 and portion 115 are salient regions of social media post 111, as described in more detail below. In some embodiments, a salient portion of the image or video of the unstructured media content item is a portion of the image or video that corresponds to structured media content. For example, the salient portion of the user-generated video is the movie clip from “Cars” as opposed to the video cutout of the person at 113 providing commentary.

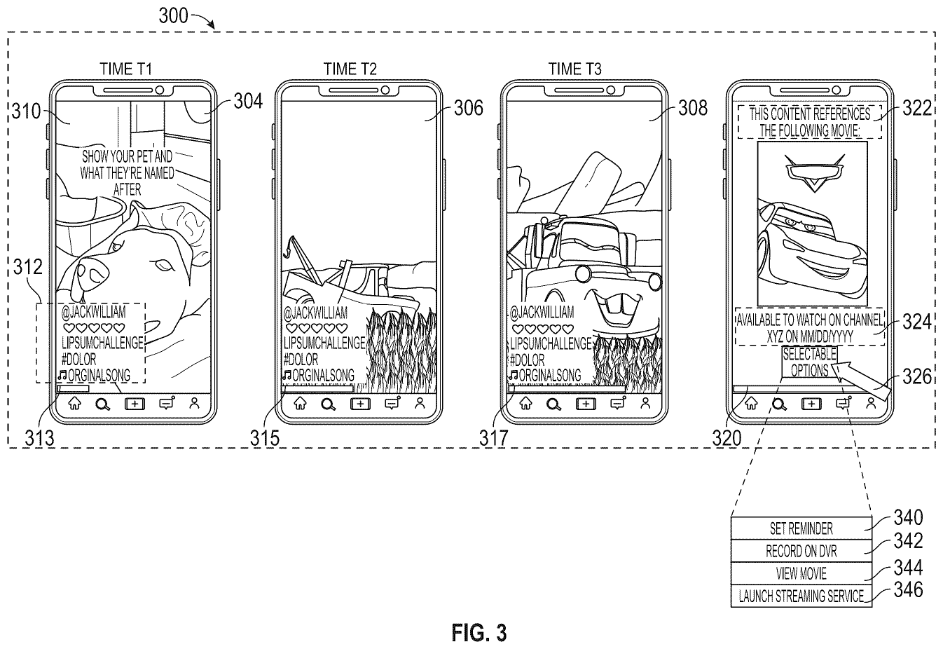

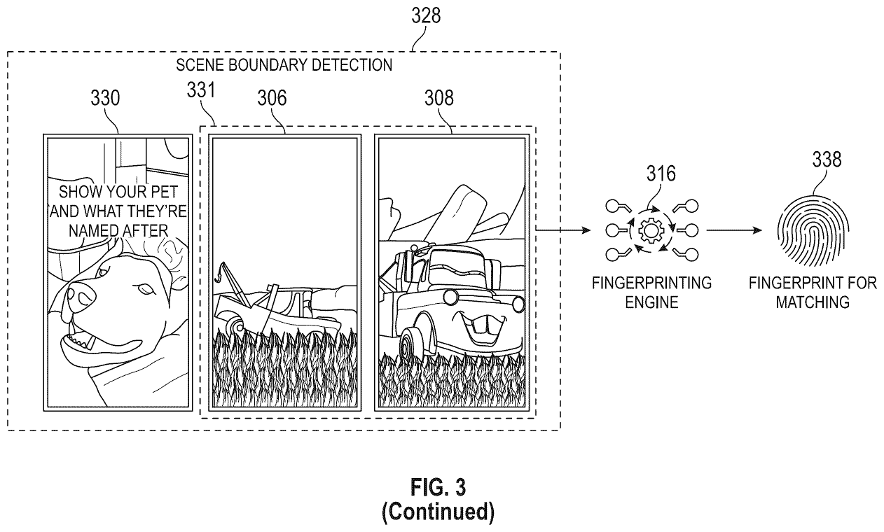

For example, unstructured media content item 110 may be UGC in which a content creator splices a movie clip from a structured media content item, such as, for example, the movie “Cars,” on which another image, text, and/or video (e.g., the creator reacting to or explaining the “Cars” clip, or, as shown in FIG. 3, a meme of a dog, or any other suitable content) is overlaid. As discussed, content analysis system 100 may process the unstructured media content item 110 to identify portion 113 of the video cutout of the person narrating the story from the movie clip and create a segmentation mask to differentiate such portion 113 from portion 115.

In some embodiments, the segmentation mask may be generated based on, in parallel with, or as an output of, the image segmentation. In some embodiments, the segmentation mask may be usable to extract portion 113 from unstructured media content item 110, at 112. In some embodiments, the segmentation mask may comprise a vector comprising any suitable number of dimensions, e.g., specifying pixel value information and/or encoding information regarding a depth of the object. In some embodiments, the segmentation mask may be a bitmap in which a first value (e.g., “0”) indicates that a pixel is outside the mask and a second value (e.g., “1”) indicates that a pixel is part of the mask. In some embodiments, the segmentation mask may be a binary mask, and/or may define the boundaries of a particular object, and/or may be used to refine the results of the image segmentation.

As a result of the segmenting and masking, at 112, unstructured media content item 110 may comprise at least one empty region (e.g., a hole) at a region of unstructured media content item 110 at which portion 113 was previously present, prior to being segmented out. As shown at 114, content analysis system 100 may perform modifying of the unstructured media content item depicted at 112 by completing (e.g., by interpolation or extrapolation of image content) or inpainting of the region(s) of unstructured media content item 110 at which portion 113 was previously depicted. In some embodiments, such inpainting may be performed using one or more of the techniques described in Zheng et al., “Image Inpainting with Cascaded Modulation GAN and Object-Aware Training,” Computer Vision—ECCV 2022: 17th European Conference, Tel Aviv, Israel, Oct. 23-27, 2022, Proceedings, Part XVI, the contents of which are hereby incorporated by reference herein in its entirety. In some embodiments, the inpainting may be performed over various frames of a video of portion 113, to infer and fill in gaps of what such region should look like. In some embodiments, a generative fill algorithm may be employed.

Fingerprinting engine 116 of content analysis system 100 may perform fingerprinting of the modified unstructured media content item 114, e.g., modified by having portion 113 be segmented and masked out, and may apply inpainting where portion 113 was previously present, to obtain fingerprint 118 of the modified unstructured media content item 114. For example, fingerprinting engine 116 may employ a perceptual hash algorithm to create a distinct fingerprint for modified unstructured media content item 114, using various features and/or characteristics (e.g., image, video, audio, and/or text) of media content item 114. In some embodiments, the fingerprint may be a hash value generated by hash codes. The hash code may be based on a cryptographic algorithm, or other suitable mathematical algorithms for the hash code. In some embodiments, the fingerprint may be represented by one or more matrices. In some embodiments, content analysis system 100 may obtain a fingerprint for media content item 114 based at least in part on passing a bitstream corresponding to media content item 114 to a hash function to obtain a deterministically generated hash of the data corresponding to media content item 114. Perceptual hashes are similar to standard checksums; however, instead of comparing hashes to establish exact matches between files at the bit level, they establish similarity of content as would be perceived by a viewer or listener.

Content analysis system 100 may perform fingerprint matching at 120 by comparing the fingerprint of modified unstructured media content item 114 obtained at 118 to one or more fingerprints stored at database 122, which may be a reference catalog of a plurality of fingerprints for a plurality of long-form media content items. In some embodiments, database 122 may store, for each long-form media content item, a plurality of fingerprints that respectively correspond to a plurality of scenes or portions of the long-form media content item. Upon determining that the fingerprint of modified unstructured media content item 114 obtained at 118 matches a fingerprint stored at database for reference catalog 122, content analysis system 100 may identify a long-form media content item (e.g., the movie “Cars” shown at 134) to which the fingerprint stored in database 122 corresponds, system 100 may retrieve data (e.g., metadata) related to long-form media content item 134. Such metadata may be used to perform an action, such as, for example, retrieve information for presentation, to generate for display an option to view, record, set a reminder for long-form media content item 134, to disambiguate a future search query based on the metadata of long-form media content item 134 (now also associated with previously unstructured media content item 110), and/or any other suitable actions

Content analysis system 100 may perform an action in relation to such long-form content (e.g., providing for display a recommendation to device 103, such as via a profile of user 106 with the short-form content platform 104 or via the long-form content platform 105, to consume a full-length version of the movie). In some embodiments, system 100 (e.g., long-form content platform 105) may maintain metadata for such long-form media content item 134 at database 136. For example, an identifier for the movie “Cars” may be associated in database 122 with a fingerprint of a scene of “Cars” that matches portion 115 of unstructured media content item 110. In some embodiments, determining that a fingerprint of modified unstructured media content item 114 obtained at 118 matches a fingerprint stored at database 122 comprises comparing hash values of the respective fingerprints. In some embodiments, being within a threshold level of similarity may constitute a match between the compared fingerprints. In some embodiments, based on the determined match of fingerprints, unstructured media content item 110 may be associated with metadata related to a scene of “Cars” corresponding to the matching fingerprint stored at database 122, to enable media content item 110 to be a structured media content item with suitable metadata to facilitate future access of content or options related to the scene of “Cars,” without having to reperform fingerprint generation and comparison.

In some embodiments, content analysis system 100 compares the fingerprint obtained at 118 of unstructured media content item 110 to a reference catalog or database 122 of fingerprints 124, 126, 128, 130, and 132 in a fingerprint matching process 120. Reference catalog 122 may comprise a plurality of fingerprints of clips or scenes of structured media content items, which may correspond to long-form content (e.g., full movies or full episodes, or a duration of content otherwise exceeding a threshold). In some embodiments, reference catalog 122 may comprise fingerprints of structured media content items from a structured media content platform. A structured media content platform may be, for example, a video streaming platform, an over-the-top (OTT) platform, any content database or platform comprising structured media content items, or any combination thereof. For example, reference catalog 122 may comprise fingerprints of scenes from all content (or a subset of content) available on a streaming content provider e.g., Netflix. Content analysis system 100 compares the fingerprint 118 of unstructured media content item 110 to at least a portion of the fingerprints of structured media content items in reference catalog 122 to identify a matching fingerprint 128 from all the fingerprints in the reference catalog. Matching fingerprint 128 corresponds to match structured media content item 134. Match structured media content item 134 corresponds to structured media content item 108. For example, fingerprint 128 corresponds to a fingerprint of an image frame of a movie scene, as shown at 134. The image frame of the movie scene corresponds to structured media content item 108, such as, for example, the movie “Cars.”

In some embodiments, generating fingerprints for short-form unstructured media content, and/or long-form structured media content, or portions thereof, may be performed using the techniques discussed in Klein et al., “Identifying Source Videos for Video Clips Based on Video Fingerprints and Embeddings”, Technical Disclosure Commons, (Mar. 6, 2024), and Sarkar et al., “Video fingerprinting: features for duplicate and similar video detection and query-based video retrieval”, Proc. SPIE 6820, Multimedia Content Access: Algorithms and Systems II, 68200E (28 Jan. 2008), the contents of each of which is hereby incorporated by reference herein in its entirety.

In some embodiments, an audio fingerprint may additionally or alternatively be generated for unstructured media content item 110, and audio fingerprints may additionally or alternatively be stored at database 122 for various portions of content items, for comparison to the generated audio signature for unstructured media content item 110. As referred to herein, the term “audio fingerprint” may refer to any kind of a digital or analog representation of a sound. The audio signature may be a digital measure of certain acoustic properties that is deterministically generated from an audio signal and may be used to identify an audio sample and/or quickly locate similar items in an audio database. For example, an audio signature may be a file, data, or data structure that stores time-domain sampling of an audio input. In another example, an audio signature may be a file, data, or data structure that stores a frequency-domain representation (e.g., a spectrogram) of an audio input.

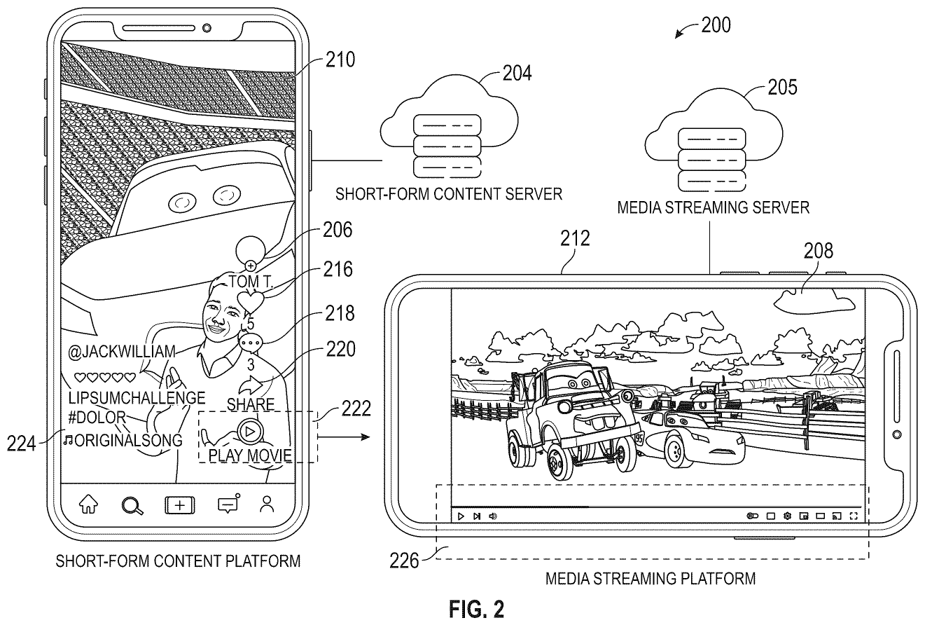

FIG. 2 shows an illustrative example of system 200 for providing matched structured media content item 208 corresponding to an unstructured media content item 210, in accordance with some embodiments of this disclosure. System 200 may correspond to content analysis system 100 of FIG. 1. As shown in FIG. 2, unstructured media content item 210 is hosted on a short-form content server 204. For example, a short-form media content, such as a video short, may be hosted on a social media platform server and displayed on device running the social media platform user interface. In some embodiments, short-form content server 204 may provide an option 222 to view the matched structured media content item 208 corresponding to unstructured media content item 210.

In some embodiments, matched structured media content item 208 is hosted on media streaming server 204. For example, at least a portion of the video short may match with a structured media content item offered by a media streaming service hosted on a media streaming server 205.

In some embodiments, unstructured media content item 210 may comprise descriptive data 224 that is created by a user on the short-form content platform. In some embodiments, the basic metadata may comprise a name of the media content item creator, a username of the creator, a short description of the unstructured media content item by the creator, hashtags, tags, location data, song name, audio data, links, emojis, any other type of data added by the creator when the unstructured media content item was posted on the short-form content platform, or a combination thereof. Such basic metadata may often be insufficient, on its own, to identify content item 208.

In some embodiments, unstructured media content item 210 may be linked with a user profile 206. For example, a short-form content may be created by user 206 and be linked to the social media profile of user 206.

In some embodiments, unstructured media content item 210 may be associated with engagement data such as, for example, the number of views, the number of likes 216 the media content item receives, the comments 218 the media content item receives, sharing options 220 for the content item, reposts, reshares, dislikes, other types of engagement metrics, or any other suitable option or data, or any suitable combination thereof.

In some embodiments, the short-form content server 204 may provide an option 222 in the short-form content platform user interface to access structured media content item 208 related to unstructured media content item 210 on media-streaming platform 226. Selection of the option 222 may initiate the media-streaming platform interface 212 on the device to provide the related structured media content item 208. For example, the short-form content platform may receive a selection of option 222 during a display of unstructured media content item 210, which has a scene of the movie “Cars” in the background of the video. The short-form content server 204 may communicate with media streaming server 205 to access data related to the movie “Cars.” Media streaming server 205 may send the data related to the movie “Cars” to the short-form content server 204, and the short-form content server may use the received data to provide information about “Cars” to the user device, providing an interface for the short-form content platform to the user. In some embodiments, the short-form content server 204 may use the received data to initiate the media-streaming platform 226 on the user device. For example, after receiving selection of option 222, the device may initiate a movie streaming app and begin playback of the movie “Cars.” In some embodiments, the playback of the structured media content item 208 may begin at a timepoint of the scene referenced in the unstructured media content item 210. In some embodiments, other structured media related to structured media content item 208 may be accessed in response to receiving the selection of option 222. Other structured media items may be deleted scenes, bloopers, options to rent structured media content item 208, options to purchase structured media content item 208, options to subscribe to the content source that offers structured media content item 208, options to form a group watch to watch structured media content item 208 with other users, other types of media items comprising structured data that are related to structured media content item 208, or any suitable other option or data, or any suitable combination thereof.

FIG. 3 shows a system diagram of system 300 for detecting scene boundaries 328 of an unstructured media content item 310 and retrieving data related to a structured media content item corresponding to unstructured media content item 310, in accordance with some embodiments of this disclosure. System 300 may correspond to systems 100 and 200 of FIGS. 1 and 2.

As shown in FIG. 3, system 300 performs scene boundary detection 328 on unstructured media content item 310. In the example of FIG. 3, unstructured media content item 310 is a video short comprising scenes 304, 306, and 308 occurring at times T1, T2, and T3, respectively, with T1 occurring earlier than T2, and T2 occurring earlier than T3, within the video short. In the example of FIG. 3, scene 304 may be a UGC clip showing the content clip creator's dog, or any other image or video of a dog, and the subtitle “Show your pet and what they're named after.” Scene 306 is a playback position of a clip from “Cars,” and scene 308 is a later playback position of the same clip from “Cars.” In some embodiments, unstructured media content item 310 may have a video playback progress bar to indicate the duration of the video short. For example, scene 304 occurs at playback position 313, scene 306 occurs at playback position 315, and scene 308 occurs at playback position 317. While scene 304 in the illustrative example does not depict of a scene from the movie “Cars,” this may not always be the case, and may be a creative decision by the content creator.

In some embodiments, unstructured media content item 310 may comprise descriptive data 312 that is created by a user on the short-form content platform. In some embodiments, the basic metadata may comprise a name of the media content item creator, a username of the creator, a short description of the unstructured media content item by the creator, hashtags, tags, location data, song name, audio data, links, emojis, any other type of data added by the creator when the unstructured media content item was posted on the short-form content platform, or a combination thereof.

In some embodiments, system 300 performs scene boundary detection 328 on unstructured media content item 310 using any suitable computer-implemented technique. For example, system 300 may use a scene boundary detection algorithm, an image analysis algorithm, or any other artificial intelligence-based or machine learning-based image detection process to determine boundaries between scenes 304, 306, and 308. The system may determine that scene 304 belongs within a first scene boundary 330 and that scenes 306 and 308 belong to the same scene and within a second scene boundary 331. For example, scenes 306 and 308 belong to the same video clip in “Cars.” The system determines that the two scenes belong to the same video clip and identifies a scene boundary between scene 304 and scenes 306 and 308. The system determines that scene 304 belongs within scene boundary 330 and that scenes 306 and 308 belong within scene boundary 331.

In some embodiments, the system may use similar techniques to identify a scene (e.g., a meme or reaction video 304) that is user-generated and a scene that is from a structured media content item, such as a long-form media content item. For example, the scene boundary detection process 328 may identify that scene 304 is user-generated and that the scene(s) within scene boundary 331 is from a movie or other structured media content item. The system may send images or videos from the scene(s) within scene boundary 331 to fingerprinting engine 316 to generate a fingerprint 338 of the portion of the unstructured media content item that is not user-generated. In some embodiments, system 300 may determine that scenes 306 and 308 likely correspond to the same content (e.g., a clip of a structured media content item) based on the similarities of their objects, coloring, lighting and/or other characteristics, whereas scene 304 likely does not correspond to the same type of content as scenes 306 and 308, e.g., and that scene 304 thus is likely unstructured user-generated content.

In some embodiments, system 300 may use fingerprinting engine 316 to generate fingerprints for scenes 304,306, and 308. The system may search for a fingerprint match from the reference catalog (not shown) for fingerprints of scenes 304, 306, and 308 (or only scenes 306, and 308 corresponding to a long-form media content item).

In some embodiments, system 300 may generate fingerprints for unstructured media content item 310 based on time stamps of the unstructured media content item. For example, system 300 may generate a fingerprint of a frame at every second (or other suitable interval) of unstructured media content item 310. In some embodiments, system 300 may generate a predetermined number of fingerprints for unstructured media content item 310 based on equally spaced time stamps of the unstructured media content item. For example, system 300 may determine that the unstructured media content item lasts 10 seconds, and that five fingerprints should be generated of the unstructured media content item, and thus system 300 may then generate a fingerprint of a frame at every two seconds of the unstructured media content item.

In some embodiments, fingerprinting engine 316 may take in video input. System 300 may input at least a portion of video scene(s) within/after scene boundary 331 into fingerprinting engine 316 and output one or more fingerprints 338 for use during fingerprint matching.

In some embodiments, system 300 may determine that one of the scenes in unstructured media content item 310 matches at least a portion of a structured media content item. System 300 may provide viewing options for the structured media content item at the end of the playback of unstructured media content item 310 at playback position 320, or during playing of unstructured media content item 310. For example, system 300 may determine, based on fingerprint comparison, that scenes 306 and/or 308 matches a scene from the movie “Cars” and provide for display an option to view the movie “Cars” at the end of the video short. At 322, system 300 may indicate that the unstructured media content item references a structured media content item such as a long-form media content item. At 324, system 300 may indicate an availability of the structured media content item. For example, system 300 may indicate that the movie “Cars” is available to watch on Channel XYZ on date MM/DD/YYYY, or is available to access on demand from one or more content sources.

In some embodiments, system 300 may display options 326 to access the structured media content item on the short-form content platform interface. The user may be presented with the actual movie reference and provided options to view on their long-form content platform. For example, options 326 may comprise an option to create a reminder 346 to watch the structured media content item 340, an option 342 to record the structured media content item on digital video recorder (DVR) or cloud DVR, an option 344 to view the structured media content item 344, an option to launch 346 a streaming service to stream the structured media content item 346, or any other option related to the matching structured media content item. In some embodiments, such options may be provided on a same device that accessed unstructured media content item 310, or a different device, e.g., a television in a vicinity of unstructured media content item 310.

In some embodiments, the generated fingerprint obtained at 316 may be associated with a profile of the user, e.g., the user having accessed unstructured media content item 310, and used at a later time. For example, while the same user is accessing a long-form content platform at a later time, the long-form content platform may receive a query or command of “Show me the movie with the chef hat on dog.” While typically it may be difficult for the long-form content platform to understand and interpret the query to return useful results, in this instance, since metadata for unstructured media content item 310 (e.g., data tags) describes the dog with the chef hat, and its association with the movie “Cars,” the long-form content platform may interpret the received query in view of such metadata, and may return a recommendation to view the movie “Cars,” and/or any other suitable data or options related to “Cars.” The account or profile of the user with the short-form content platform may be linked or associated with the account or profile of the long-form content platform. For example, interaction history and/or preferences of the user on the respective platform may be shared amongst the profiles.

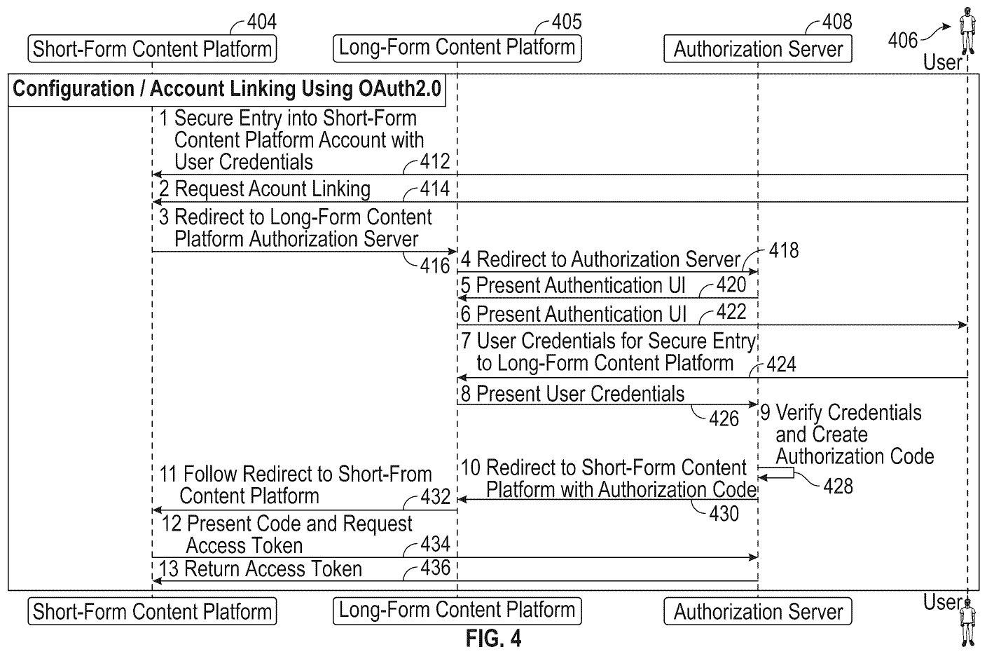

FIG. 4 is a flowchart of an illustrative process 400 for associating a short-form content platform 404 and a long-form content platform 405, in accordance with some embodiments of this disclosure.

As shown in FIG. 4, short-form content platform 404 may be associated with or linked to long-form content platform 405 using an authorization protocol, such as, for example, OAuth 2.0, cloud APIs and/or any other suitable protocol. User 406 may have an account or profile on both short-form content platform 402 and long-form content platform 405 and links those accounts together using the authorization protocol. The system may use an authorization server 408 to verify the credentials of the user account on the short-form content platform 404 and the long-form content platform 405 to allow transfer or sharing of data between the platforms.

Since the short-form content platform requests resources from the long-form content platform 405, the long-form content platform 405 provides an authorization server 408 to which the short-form content platform 404 can direct users during account linking. Successful account-linking generates an access token that is used on behalf of the user when the short-form content platform 404 invokes resources from the long-form content platform 405. The short-form content platform 404 seeks to direct the user to relevant content on the long-form platform 405. That is, the short-form content platform seeks authorization for certain resources on the long-form content platform on behalf of the user through an API call.

At 412, short-form content platform 404 receives login information from user 406 to access short-form content platform 404 on a user device, and short-form content platform 404 secures entry into the short-form content platform's user account with user credentials provided by user 406. At 414, short-form content platform 404 receives a request from user 406 on the user device to link the short-form content platform account to a long-form content platform account.

At 416, short-form content platform 404 initiates an authorization process to access long-form content platform 405. In some embodiments, user 406 accessing short-form content platform's interface may be redirected to an authorization page on long-form content platform 405's interface. In some embodiments, the authorization page may be on short-form content platform's interface.

At 418, long-form content platform 405 initiates the authorization process by redirecting to authorization server 408, which connects both short-form content platform 402 and long-form content platform 405. At 420, long-form content platform 405 may present an authentication user interface, such as a log-in page, on the long-form content platform interface.

At 422, long-form content platform 405 may present an authentication user interface, such as a log-in page, to user 406 on a user device accessing the long-form content platform. At 424, long-form content platform 405 receives login information from user 406 to access long-form content platform 405 on the user device. Long-form content platform 405 secures entry into the long-form content platform's user account with user credentials given by user 406.

At 426, long-form content platform 405 the sends the user credentials received from user 406 on the user device to authorization server 408. At 428, authorization server 408 verifies the user credentials received from long-form content platform 405 and creates an authorization code.

At 430, authorization server 408 sends the authorization code back to long-form content platform 405. At 432, long-form content platform 405 redirects back to short-form content platform 402 with the authorization code.

At 434, short-form content platform presents to authorization server 408 the received authorization code and a request access token. At 436, after receiving the access token, authorization server 408 returns the access token to short-form content platform 402 along with communication data to communicate with long-form content platform 405.

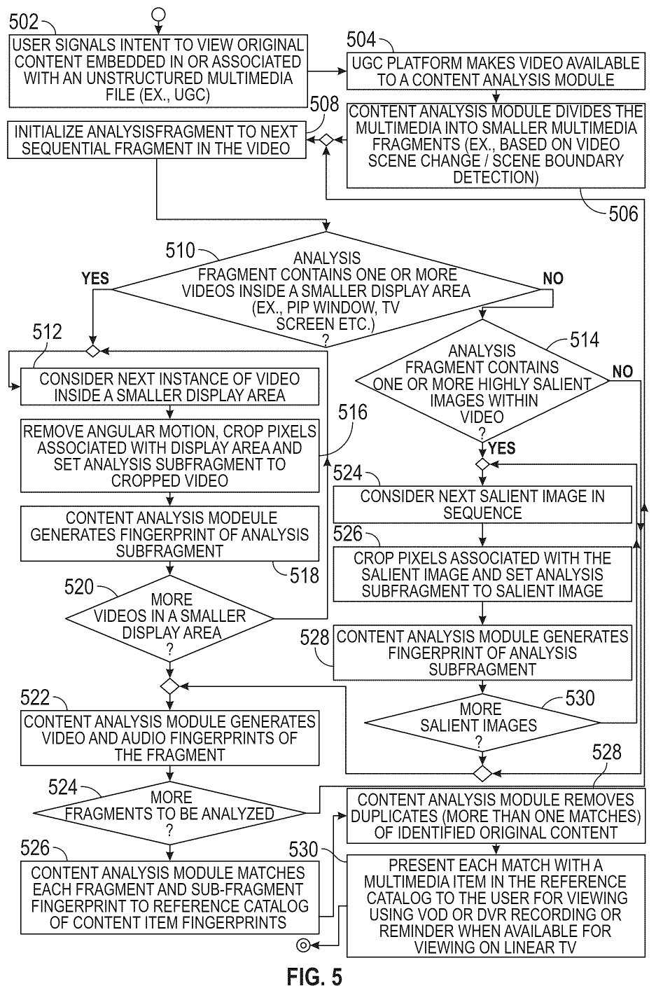

FIG. 5 is a flowchart of an illustrative process 500 for fingerprinting a content item using a content analysis module, in accordance with some embodiments of this disclosure.

At 502, a user on a user device signals on intent to view original content (e.g., structured media content item or long-form media content item) embedded in or associated with an unstructured multimedia file (e.g., a user-generated content item). For example, the user may select an option to request identification of content in the short-form, or utter a voice command “What is the name of this movie?” while accessing the short-form content item. In some embodiments, the system may perform this analysis without a user request. For example, such analysis may be performed at ingest/intake of the short-form content by the platform. In some embodiments, the system may receive the unstructured multimedia file directly through the short-form content platform (e.g., automatically, such as part of a partnership or arrangement between the short-form content platform and the system).

Creators may splice movie content (or other structured media content items) into their UGC in multiple ways. For example, they may insert a short audio/video clip, perhaps modified (e.g., slowed down) into the content. They may insert a video clip as a PiP window. They may digitally overlay an iconic movie image on the video or have an iconic image as (a visually salient) part of their background. A content analysis module (e.g., 102 of FIG. 1 of content analysis system 100) may process/analyze the UGC from various viewpoints to detect each reference to an original (e.g., structured) content item.

At 504, the short-form content platform (e.g., platform 104 of FIG. 1) makes the short-form media content item available to a content analysis module (e.g., 102 of FIG. 1 of content analysis system 100). At 506, the content analysis module divides the UGC into smaller multimedia fragments. For example, the content analysis module may divide the video short based on a video scene change or based on output from a scene boundary detection process.

Content analysis module 102 divides the UGC into smaller fragments for analysis, where such smaller fragments may be individual logical units used for fingerprinting. In some embodiments, these fragments are divided based on scene boundary detection, e.g., using a bidirectional GRU (biGRU) which predicts whether frames of a scene are at the end of a scene.

At 508, the content analysis module initializes aprocess to analyze a multimedia fragment. In some embodiments, a plurality of multimedia fragments may be sequentially ordered within a queue or list. The content analysis module initializes the process to analyze the next multimedia fragment from the sequential queue or list.

At 510, the content analysis module determines from the analysis process whether the multimedia fragment contains one or more videos inside a smaller display area. If yes, processing may continue to 512; otherwise processing may continue to 514. For example, after individual fragments are identified, content analysis module 102 may attempt to further identify sub-fragments inside each fragment. The content analysis module may determine whether the multimedia fragment displays a PiP window, a TV screen of different media in the background, overlays of media, a cutout of an object on top of other media, or otherwise any other form of detection of different media items within the same display.

At 512, having determined the one or more videos are present inside a smaller display in the multimedia fragment, the content analysis module considers the next instance of video inside a smaller display area. In some embodiments, the fragments are further subdivided to a target time unit (e.g., two seconds). The content analysis module may identify whether a video exists in the fragment inside of a smaller display area, such as, for example, in a PiP window, or another screen such as, for example, a TV, tablet, or mobile phone screen (e.g., depicted in the video).

In some embodiments, at 516, the content analysis module may remove angular motion of the smaller media item. For example, a smaller media item may be on display on a TV screen in the multimedia fragment. Since the TV may be at an angle, the content analysis module may process the media item so that the angular distortion is removed. In some embodiments, the content analysis module may crop pixels associated with the display area of the smaller media item. For example, the smaller media item may be within a PiP window in the multimedia fragment. The content analysis may crop the multimedia fragment to only show the smaller media item within the PiP window. In some embodiments, the content analysis module may identify a sub-fragment of the multimedia fragment that only includes the smaller media item and excludes other portions of the multimedia fragment.

At 518, the content analysis module generates a fingerprint of the sub-fragment of the multimedia fragment. At 520, the content analysis module may determine whether there are more smaller media items within the multimedia fragment; if so, 512, 516, and 518 may be repeated for such additional videos in the smaller display area. Otherwise, the content analysis module may determine that the multimedia fragment does not contain one or more videos inside a smaller display area, and processing may proceed to 522.

At 514, having determined that one or more videos are not included in a smaller display area in the unstructured media content item, the content analysis module may determine whether the multimedia fragment contains one or more highly salient images within the video. If so, processing proceeds to 524; otherwise processing proceeds to 522. At 524, the content analysis module considers the next instance of a salient image within the multimedia fragment. For example, the content analysis module identifies a portion of the multimedia fragment that is highly salient compared to other portions of the multimedia fragment. In some embodiments, the highly salient images may be separately fingerprinted, e.g., as compared to the UGC portion of the unstructured media content item and/or other portions of the unstructured media content item. In some embodiments, saliency values may be determined based at least in part on the techniques described in J. Liu, et al., “A simple pooling-based design for real-time salient object detection,” IEEE CVPR, 2019, the contents of which are hereby incorporated by reference herein in their entirety. In some embodiments, the system may identify a salient image to extract a display region and apply fingerprint, and thus images representing an iconic movie scene (e.g., Marlon Brando in “The Godfather”) or movie poster (which may either inherently be a part of the video scene fragment, or may be inserted digitally as an overlay by the creator) that are not explicitly given to the content identification system may still be identified.

At 526, the content analysis module may crop the multimedia fragment to include only pixels associated with the determined salient portions. In some embodiments, the content analysis module may identify a sub-fragment of the multimedia fragment that only includes pixels of the determined salient portions and excludes the portions of the multimedia fragment that are not salient.

At 528, the content analysis module generates a fingerprint of the sub-fragment of the multimedia fragment that is salient. At 530, the content analysis module may determine that whether there are additional salient images within the multimedia fragment. If so, process 500 may repeat steps 524, 526, and 528 for the additional salient images; otherwise, processing may proceed to 522.

At 522, the content analysis module may generate video and audio fingerprints of each of the multimedia fragments or sub-fragments. The content analysis module may creates individual audio and video fingerprints for each individual fragment (or subdivided fragments based on a time unit).

At 534, the content analysis module may determine whether there are more multimedia fragments to be analyzed. If so, processing may proceed to 508; otherwise processing may proceed to 536. At 536, the content analysis module matches each fragment and sub-fragment fingerprint to the reference catalog of structured media content item fingerprints (e.g., made available by the long-form media content item.

At 538, the content analysis module removes duplicates of identified original content. For example, if one fingerprint from the content analysis module already matched a content item's fingerprint from the reference catalog, the content analysis module may remove the media content item from a list of identified original content so that a second fingerprint from the content analysis module will not be matched again to the same media content item under a different matching fingerprint of the content item. For example, a media content item having multiple fingerprints of different scenes may not be referenced twice by the same user-generated content having multiple fingerprints matching the different scenes of the content item. Successful matches are then pruned by removing any duplicates (e.g., occurs if references to the same original content cross over scene boundaries, or are embedded in more than one way, such as a movie scene and a digital image overlay from the same movie).

Such audio/video fingerprinting may be effective even when a duplicate copy of the content is significantly degraded/modified from the original. In order to match a short video clip derived from short-form content to a long-form content, fingerprints of each second of the long-form video may have to be maintained. Since the analysis of short-form videos can occur offline, other techniques such as indexing/semantic understanding may be used to reduce the search space.

At 540, the content analysis module may present each match with a multimedia item in the reference catalog to the user accessing the UGC, or a reminder when available, or may perform any other suitable option based on the determined match at 538.

By identifying highly salient images, the analysis module may attempt to capture any visual overlay added by the creator in the foreground, or any image present in the background that represents an iconic movie. These sub-fragments may be separately fingerprinted. In some embodiments, an irregular shape of a salient region is converted to a regular shape. In some embodiments, the salient region in a video frame is extrapolated by segmenting out another infringing object and using inpainting to fill that area, converting the salient region into a regular shape. For example, a human may be partially blocking an iconic movie scene/poster. They may be segmented, masked out, and replaced with an in-painted region using AI techniques. Fingerprinting is subsequently performed on this in-painted image. Given that a perceptual hash is matched using similarity rather than exact match, the extent to which the salient region is un-occluded, and inpainting resembles the original image, may determine whether the derived fingerprint is sufficient to match the fingerprint of the original content item. In some embodiments, content analysis system 100 may create a segmentation mask of unstructured content item 110 to differentiate non-salient portions of unstructured content item 110 from salient portions of unstructured content item 110.

In some embodiments, once a fingerprint for a video is generated, it can be stored and used by other users as needed. In some embodiments, if a fingerprint was communicated to Service A, an identifier associated with the same fingerprint may be sufficient to send to the same provider, since the provider already has the fingerprint. This allows the re-use of existing fingerprints on both ends of the system.

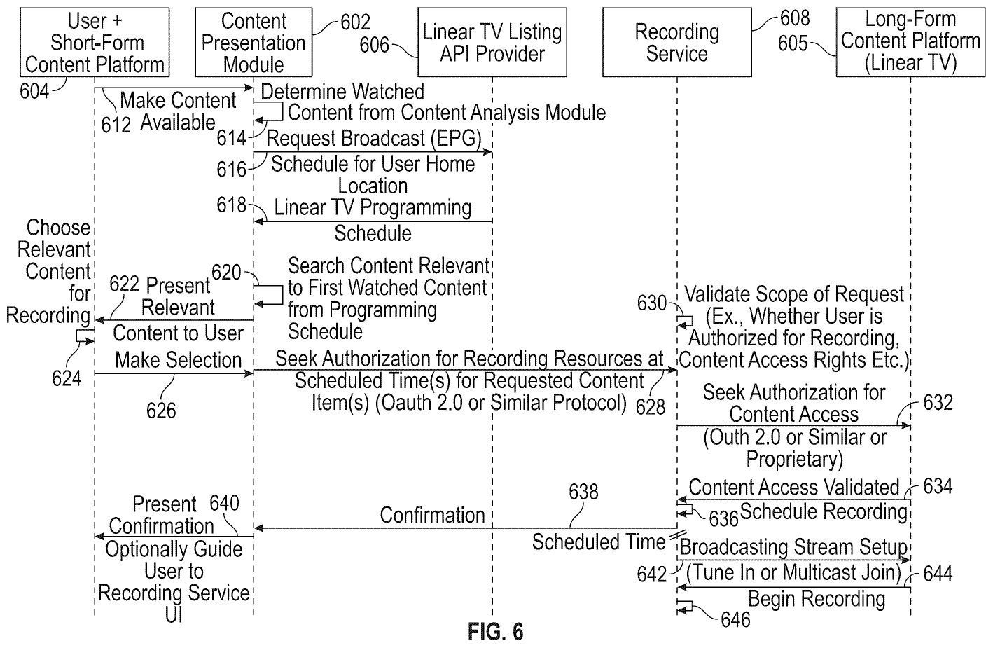

FIG. 6 is a flow diagram of an illustrative process 600 of identifying a matched media content item in a TV schedule 606 based on a viewing history, authorizing access between a short-form content platform 604 to a linear TV provider 605, and recording the matched media content item from the linear TV provider using a recording service 608, in accordance with some embodiments of this disclosure.

At 612, short-form content platform 604 makes a short-form media content item available to content presentation module 602. For example, such short-form media content item may be made available based on detecting a user is accessing such short-form content item, e.g., on a social media platform, or prior to or after such access.

At 614, content presentation module 602 determines watched content from the content analysis module (e.g., 102 of FIG. 1). For example, the content presentation module determines that the short-form media content item matches a long-form media content item in a viewing history of the user. At 616, content presentation module 602 sends a request to a linear TV listing API provider 606 for a broadcast (e.g., EPG) schedule for a location associated with the user device. At 618, content presentation module 602 receives from linear TV listing API provider 606 the linear TV programming schedule.

At 620, content presentation module 602 searches content relevant to the identified watched content from the programming schedule. At 622, content presentation module 602 presents the relevant content from the programming schedule to the user through short-form content platform 604. At 624, short-form content platform 604 receives a user selection of a relevant content for recording. At 626, short-form content platform 604 sends the selection of the relevant content for recording to content presentation module 602.

At 628, content presentation module 602 seeks authorization for recording resources at the scheduled time(s) for requested content item(s) from a recording service 608. In some embodiments, the authorization is conducted by OAuth2.0 or a similar protocol. The authorization process may be conducted as described by process 400.

At 630, recording service 608 validates the scope of the request. For example, the recording service determines whether the user is authorized to record the content based on access rights or other authorization restrictions. At 632, recording service 608 seeks authorization for the content access to long-form content platform (e.g., linear TV service) 605.

At 634, long-form content platform 605 sends validation for the content access to recording service 608. At 636, recording service 608 schedules recording of the matched content item. At 638, recording service 608 sends confirmation of the scheduled recording to content presentation module 602.

At 640, content presentation module 602 presents the confirmation to the user through short-form content platform 604. In some embodiments, short-form content platform 604 redirects the short-form content platform interface to the recording service user interface.

At 644, during the scheduled recording time 642, recording service 608 broadcasts stream setup from long-form content platform 605 of the matched content item. At 646, recording service 608 records the stream of matched media content item from long-form content platform 605.

In some embodiments, after validating access rights to each identified original content item, the validated items are presented back to the viewer with optionality. This optionality may include, if the media content item is currently available in the long-form content platform, the content item being presented as an item in the VoD catalog. In some embodiments, if the media content item is to be made available on linear TV at a later time, based on the schedule (extracted from the EPG), the user may be given an option to record the media content item using a DVR system (whether in-home or on the cloud, whether based on “private copy” or “shared copy” models as mandated by the law of the land); receive a reminder to watch the item later, closer to the scheduled play out time; or rent or purchase the content; upgrade their subscription; or subscribe to a new service (e.g., OTT application or any other suitable service).

In some embodiments, multiple platforms (e.g., short-form content platform, long-form content platform such as, for example, linear TV/VOD, programming schedule listing provider, recording service) may be account-linked. While some of the platforms may be provided by the same entity and therefore integrated (e.g., allowing single sign-on) others may be integrated using an authorization protocol such as OAuth2.0.

As shown in FIG. 6, the content presentation module receives the input from the content analysis module identifying a plurality of long-form media content items. It receives a schedule from the linear TV listing API provider and determines when the relevant original content is available for recording. If permitted by the user, this module seeks authorization from the recording service for allocating the recording resource at the scheduled time. The recording service may validate the scope of the request from the Linear TV service based on the user's subscription prior to scheduling. Similar to the content analysis module, the content presentation module may be co-located with the short-form content platform, the long-form content platform, or it may be a third party/intermediary.

In some embodiments, the recording service may automatically prompt the user (either directly, when they enter the long-form content app, or indirectly, via an API call response to the short-form content app) for additional information or use pre-stored preferences (or even historical actions) to perform an action. For example, the fingerprinted content may identify a new TV series, in which case the user may decide to record the whole season or just the few episodes, or even “Record the entire season if I watch the first three episodes,” as a non-limiting example. Users may be prompted on the same device that they were watching the short-form video on, or may see such prompt when they open the long-form video app, or at any other suitable time. In some embodiments, the system may present different options to be presented based on the metadata of the content item. For example, if the metadata indicates that the matched long-form content item is a TV series, the system may present options to record seasons or selected episodes of the TV series. In another example, the system may present options to turn on “Smart Downloads” for the content item to a user profile associated with the long-form video app, e.g., to enable the long-form content to automatically download an episode so the user can start watching.

In some embodiments, the user may be prompted to select a reminder at a specified time before the original media content item on linear TV becomes available. For example, an original content item on linear TV may be scheduled to play at 12 pm, and the system may prompt a reminder at 11 am to the user regarding the original media content item. Such a reminder may be provided either directly, within a video-viewing application of the long-form content platform (e.g., on a mobile phone), or it may be provided via integration with another service such as a voice assistant service (Outh2.0 or similar for API calling between the Linear TV service and voice assistant service). Selection of the VoD option may invoke a deep-link to the long-form content application with the matched content as a landing page.

In some embodiments, the fingerprint is used by an advertising service associated with the Pay TV provider. For example, the fingerprint maybe associated with a movie that will be shown in theaters in a month. The trailer or advertisement for such movie may then be targeted to specific users. This means that a targeted advertisement is now “inspired” by a “reminder” action (e.g., specified by the user to request that is received requesting to be notified when, or at a certain time before, content is scheduled to air or become available). This is helpful if the movie is not being promoted on the short-form app (e.g., advertisements for the movie are running on long-form video apps only).

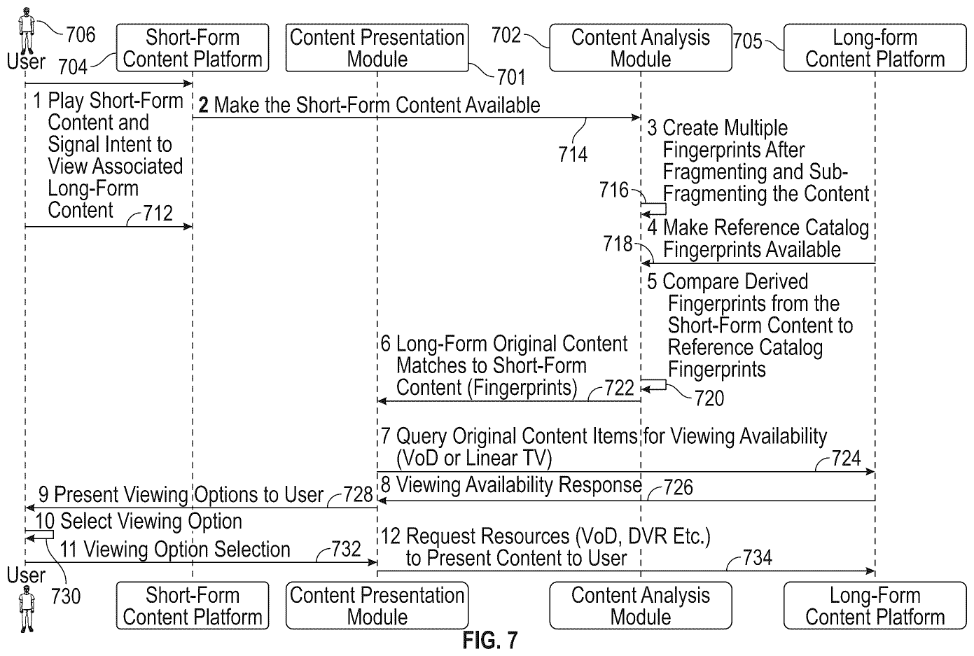

FIG. 7 is a flow diagram of an illustrative process 700 of matching a short-form content item to a long-form content item using the content analysis module 702 and presenting the viewing availabilities of the matched content to a user 706, in accordance with some embodiments of this disclosure.

At 712, a user 706 on a user device accessing short-form content platform 704 plays a short-form content item. Short-form content platform 704 receives an input from the user on the user device signaling an intent to view the associated long-form content item.

At 714, short-form content platform 704 makes the short-form content available to content analysis module 702. Content analysis module 702 accesses the short-form content by retrieving data related to the short-form content from short-form content platform 704 or by retrieving the file for the short-form content from short-form content platform 704.

At 716, content analysis module 702 creates multiple fingerprints of the short-form content after determining fragments and sub-fragments of the content as described in process 600.

At 718, content analysis module 702 accesses a reference catalog of fingerprints. In some embodiments, the content analysis module may access the reference catalog by retrieving the reference catalog from long-form content platform 705.

At 720, content analysis module 702 compares the derived fingerprints from the short-form content to the reference catalog of fingerprints.

At 722, content analysis module 702 identifies the long-form content associated with the matching fingerprint and sends data related to the long-form content to content presentation module 701.

At 724, content presentation module 701 queries long-form content platform 705 for viewing availabilities of the original content items (e.g., the long-form content). In some embodiments, the content presentation module queries for viewing availability of VoD or Linear TV of the original content items.

At 726, long-form content platform 705 sends a response with the viewing availabilities to content presentation module 701.

At 728, content presentation module 701 presents the viewing options to user 706 by displaying the viewing options through short-form content platform 704 on the user device.

At 730, short-form content platform 704 receives a selection by user 706 on the user device for a viewing option. At 732, the viewing option selection is then sent to content presentation module 701.

At 734, content presentation module 701 sends a request to long-form content platform 705 for resources to present content to the user. For example, the content presentation module may request from a media streaming server for VoD, DVR, or other viewing option of a movie.

As shown in FIG. 7, in some embodiments, the long-form content platform encompasses various features of an integrated TV platform including, for example, VOD, linear TV, EPG schedule listing service, and/or recording service (DVR/cDVR). The content analysis module may be implemented at least in part by the short-form content platform, which may invoke the reference catalog that is provided by the long-form content platform to determine the fingerprint matches between fragments and sub-fragments of the short-form content with fingerprints from the reference catalog. After the relevant content as been determined, the content presentation module queries the long-form content platform on viewing options and presents these to the user. The viewing options are presented to the user on the short-form content application. The user selections may be used to request resources (VoD, DVR or reminders) on the long-form content platform.

In some embodiments, the content analysis module is provided by the long-form content platform (to help in performing efficient searches on a reference catalog), while the content presentation module is contained within the short-form content platform (to help in presenting content directly on the short-form content platform). Thus, the long-form content platform resources may be initially invoked by the short-form content platform for analysis, and fingerprint match results may be returned. Thereafter, the long-form content platform resources may be again invoked by the short-form content platform to determine viewing options. In some embodiments, a third-party system may interface with system 100, and the third-party service may provide on-the-fly content analysis of short-form and/or long-form content, and/or fingerprint generation and matching.

In some embodiments, the reference catalog may store multiple fingerprint entries relevant to a media content item in a data structure that is efficiently searched. For example, the entire media content item (or its most memorable/salient parts) may be broken into small fragments three to five seconds long. Other assets relevant to the media content item such as, for example, movie posters, iconic scenes, trailers, behind-the-scenes clips, or any other suitable items or data, may also be fingerprinted and available in the catalog for matching with a derived fingerprint. In particular, content clips and collateral assets that have been provided to other platforms under license, may be fingerprinted as they are likely to get used by creators in developing UGC items.

FIGS. 8-9 show illustrative devices and systems for identifying a structured media content item corresponding to at least a portion of an unstructured media content item, in accordance with some embodiments of this disclosure. FIG. 8 shows generalized embodiments of illustrative computing devices 800 and 801, which may correspond to, e.g., a smart phone, a tablet, a laptop computer, a personal computer, a desktop computer, a smart television, a smart watch or wearable device, smart glasses, a stereoscopic display, a wearable camera, virtual reality (VR) glasses, VR goggles, a stereoscopic display, augmented reality (AR) glasses, an AR head-mounted display (HMD), a VR HMD, or any other suitable computing device, or any combination thereof. In another example, computing device 801 may be a user television equipment system or device.

User television equipment device 801 may include set-top box 815. Set-top box 815 may be communicatively connected to microphone 816, Audio output equipment (e.g., speaker or headphones 814), and display 812. In some embodiments, microphone 816 may receive audio corresponding to a voice of a user providing input. In some embodiments, display 812 may be a television display or a computer display. In some embodiments, set-top box 815 may be communicatively connected to user input interface 810. In some embodiments, user input interface 810 may be a remote control device. Set-top box 815 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 9. In some embodiments, computing device 800 may comprise any suitable number of sensors (e.g., gyroscope or gyrometer, or accelerometer, etc.), and/or a GPS module (e.g., in communication with one or more servers and/or cell towers and/or satellites) to ascertain a location of computing device 800. In some embodiments, computing device 800 comprises a rechargeable battery that is configured to provide power to the components of the device.

Each one of computing device 800 and computing device 801 may receive content and data via input/output (I/O) path 802. I/O path 802 may provide content (e.g., broadcast programming, on-demand programming, Internet content, content available over a local area network (LAN) or wide area network (WAN), and/or other content) and data to control circuitry 804, which may comprise processing circuitry 806 and storage 808. Control circuitry 804 may be used to send and receive commands, requests, and other suitable data using I/O path 802, which may comprise I/O circuitry. I/O path 802 may connect control circuitry 804 (and specifically processing circuitry 806) to one or more communications paths (described below). I/O functions may be provided by one or more of these communications paths, but are shown as a single path in FIG. 8 to avoid overcomplicating the drawing. While set-top box 815 is shown in FIG. 3 for illustration, any suitable computing device having processing circuitry, control circuitry, and storage may be used in accordance with the present disclosure. For example, set-top box 815 may be replaced by, or complemented by, a personal computer (e.g., a notebook, a laptop, a desktop), a smartphone (e.g., computing device 800), an XR device; a tablet; a network-based server hosting a user-accessible client device; a non-user-owned device; any other suitable device; or any combination thereof.

Control circuitry 804 may be based on any suitable control circuitry such as processing circuitry 806. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 804 executes instructions for the content analysis system or application stored in memory (e.g., storage 808). Specifically, control circuitry 804 may be instructed by the content analysis system or application to perform the functions discussed above and below. In some implementations, processing or actions performed by control circuitry 804 may be based on instructions received from the content analysis system or application.

In client/server-based embodiments, control circuitry 804 may include communications circuitry suitable for communicating with a server or other networks or servers. The content analysis system or application may be a stand-alone application implemented on a device or a server. The content analysis system or application may be implemented as software or a set of executable instructions. The instructions for performing any of the embodiments discussed herein of the content analysis system or application may be encoded on non-transitory computer-readable media (e.g., a hard drive, random-access memory on a DRAM integrated circuit, read-only memory on a BLU-RAY disk, etc.). For example, in FIG. 3, the instructions may be stored in storage 808, and executed by control circuitry 804 of a device 800.

In some embodiments, the content analysis system or application may be a client/server application where only the client application resides on device 800 (e.g., device 103 of FIG. 1), and a server application resides on an external server (e.g., server 904 and/or server 904). For example, the content analysis system or application may be implemented partially as a client application on control circuitry 804 of device 800 and partially on server 904 as a server application running on control circuitry 911. Server 904 may be a part of a local area network with one or more of devices 800, 801 or may be part of a cloud computing environment accessed via the Internet. In a cloud computing environment, various types of computing services for performing searches on the Internet or informational databases, providing video communication capabilities, providing storage (e.g., for a database) or parsing data are provided by a collection of network-accessible computing and storage resources (e.g., server 904 and/or an edge computing device), referred to as “the cloud.” Device 800 may be a cloud client that relies on the cloud computing capabilities from server 904 to determine whether processing (e.g., at least a portion of virtual background processing and/or at least a portion of other processing tasks) should be offloaded from the mobile device, and facilitate such offloading. When executed by control circuitry of server 904, the content analysis system or application may instruct control circuitry 911 to perform processing tasks for the client device and facilitate the generation of multi-layer images. The client application may instruct control circuitry 804 to determine whether processing should be offloaded.

Control circuitry 804 may include communications circuitry suitable for communicating with a server, edge computing systems and devices, a table or database server, or other networks or servers The instructions for carrying out the above mentioned functionality may be stored on a server (which is described in more detail in connection with FIG. 9. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 9). In addition, communications circuitry may include circuitry that enables peer-to-peer communication of computing devices, or communication of computing devices in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 808 may be used to store various types of content described herein as well as the content analysis system or application data described above. Nonvolatile memory may also be used (e.g., to launch a boot-up routine and other instructions). Cloud-based storage, described in more detail in relation to FIG. 9, may be used to supplement storage 808 or instead of storage 808.

Control circuitry 804 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 804 may also include scaler circuitry for upconverting and downconverting content into the preferred output format of computing device 800. Control circuitry 804 may also include digital-to-analog converter circuitry and analog-to-digital converter circuitry for converting between digital and analog signals. The tuning and encoding circuitry may be used by computing device 800, 801 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 808 is provided as a separate device from computing device 800, the tuning and encoding circuitry (including multiple tuners) may be associated with storage 808.

Control circuitry 804 may receive instruction from a user by way of user input interface 810. User input interface 810 may be any suitable user interface, such as a remote control, mouse, trackball, keypad, keyboard, touch screen, touchpad, stylus input, joystick, voice recognition interface, or other user input interfaces. Display 812 may be provided as a stand-alone device or integrated with other elements of each one of computing device 800 and computing device 801. For example, display 812 may be a touchscreen or touch-sensitive display. In such circumstances, user input interface 810 may be integrated with or combined with display 812. In some embodiments, user input interface 810 includes a remote-control device having one or more microphones, buttons, keypads, any other components configured to receive user input or combinations thereof. For example, user input interface 810 may include a handheld remote-control device having an alphanumeric keypad and option buttons. In a further example, user input interface 810 may include a handheld remote-control device having a microphone and control circuitry configured to receive and identify voice commands and transmit information to set-top box 815.

Audio output equipment 814 may be integrated with or combined with display 812. Display 812 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 812. Audio output equipment 814 may be provided as integrated with other elements of each one of computing device 800 and computing device 801 or may be stand-alone units. An audio component of videos and other content displayed on display 812 may be played through speakers (or headphones) of audio output equipment 814. In some embodiments, audio may be distributed to a receiver (not shown), which processes and outputs the audio via speakers of audio output equipment 814. In some embodiments, for example, control circuitry 804 is configured to provide audio cues to a user, or other audio feedback to a user, using speakers of audio output equipment 814. There may be a separate microphone 816 or audio output equipment 814 may include a microphone configured to receive audio input such as voice commands or speech. For example, a user may speak letters or words or terms or numbers that are received by the microphone and converted to text by control circuitry 804. In a further example, a user may voice commands that are received by a microphone and recognized by control circuitry 804. Camera 818 may be any suitable video camera integrated with the equipment or externally connected. Camera 818 may be a digital camera comprising a charge-coupled device (CCD) and/or a complementary metal-oxide semiconductor (CMOS) image sensor. Camera 818 may be an analog camera that converts to digital images via a video card.

The content analysis system or application may be implemented using any suitable architecture. For example, it may be a stand-alone application wholly-implemented on each one of computing device 800 and computing device 801. In such an approach, instructions of the application may be stored locally (e.g., in storage 808), and data for use by the application is downloaded on a periodic basis (e.g., from an out-of-band feed, from an Internet resource, or using another suitable approach). Control circuitry 804 may retrieve instructions of the application from storage 808 and process the instructions to provide video conferencing functionality and generate any of the displays discussed herein. Based on the processed instructions, control circuitry 804 may determine what action to perform when input is received from user input interface 810. For example, movement of a cursor on a display up/down may be indicated by the processed instructions when user input interface 810 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 804 may allow a user to provide user profile information or may automatically compile user profile information. For example, control circuitry 804 may access and monitor network data, video data, audio data, processing data, participation data from a conference participant profile. Control circuitry 804 may obtain all or part of other user profiles that are related to a particular user (e.g., via social media networks), and/or obtain information about the user from other sources that control circuitry 804 may access. As a result, a user can be provided with a unified experience across the user's different devices.

In some embodiments, the content analysis system or application is a client/server-based application. Data for use by a thick or thin client implemented on each one of computing device 800 and computing device 801 may be retrieved on-demand by issuing requests to a server remote to each one of computing device 800 and computing device 801. For example, the remote server may store the instructions for the application in a storage device. The remote server may process the stored instructions using circuitry (e.g., control circuitry 804) and generate the displays discussed above and below. The client device may receive the displays generated by the remote server and may display the content of the displays locally on computing device 800. This way, the processing of the instructions is performed remotely by the server while the resulting displays (e.g., that may include text, a keyboard, or other visuals) are provided locally on computing device 800. Computing device 800 may receive inputs from the user via input interface 810 and transmit those inputs to the remote server for processing and generating the corresponding displays. For example, computing device 800 may transmit a communication to the remote server indicating that an up/down button was selected via input interface 810. The remote server may process instructions in accordance with that input and generate a display of the application corresponding to the input (e.g., a display that moves a cursor up/down). The generated display is then transmitted to computing device 800 for presentation to the user.

In some embodiments, the content analysis system or application may be downloaded and interpreted or otherwise run by an interpreter or virtual machine (run by control circuitry 804). In some embodiments, content analysis system or application may be encoded in the ETV Binary Interchange Format (EBIF), received by control circuitry 804 as part of a suitable feed, and interpreted by a user agent running on control circuitry 804. For example, the content analysis system or application may be an EBIF application. In some embodiments, the content analysis system or application may be defined by a series of JAVA-based files that are received and run by a local virtual machine or other suitable middleware executed by control circuitry 804. In some of such embodiments (e.g., those employing MPEG-2, MPEG-4, HEVC or any other suitable digital media encoding schemes), the content analysis system or application may be, for example, encoded and transmitted in an MPEG-2 object carousel with the MPEG audio and video packets of a program.

XR may be understood as virtual reality (VR), augmented reality (AR) or mixed reality (MR) technologies, or any suitable combination thereof. VR systems may project images to generate a three-dimensional environment to fully immerse (e.g., giving the user a sense of being in an environment) or partially immerse (e.g., giving the user the sense of looking at an environment) users in a three-dimensional, computer-generated environment. Such environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world or the real world is otherwise connected to virtual objects.

FIG. 9 is a diagram of an illustrative system 900 for enabling user controlled extended reality, in accordance with some embodiments of this disclosure. Computing devices 907, 908, 910 (which may correspond to, e.g., computing device 800 or 801) may be coupled to communication network 909. Communication network 909 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 909) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 9 to avoid overcomplicating the drawing.

Although communications paths are not drawn between computing devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The computing devices may also communicate with each other directly through an indirect path via communication network 909.

System 900 may comprise media content source 902, one or more servers 904, and/or one or more edge computing devices. In some embodiments, content analysis system or application may be executed at one or more of control circuitry 911 of server 904 (and/or control circuitry of computing devices 907, 908, 910 and/or control circuitry of one or more edge computing devices). In some embodiments, the media content source and/or server 904 may be configured to host or otherwise facilitate video communication sessions between computing devices 907, 908, 910 and/or any other suitable computing devices, and/or host or otherwise be in communication (e.g., over network 909) with one or more social network services.

In some embodiments, server 904 may include control circuitry 911 and storage 914 (e.g., RAM, ROM, Hard Disk, Removable Disk, etc.). Storage 914 may store one or more databases. Server 904 may also include an input/output path 912. I/O path 912 may provide video conferencing data, device information, or other data, over a local area network (LAN) or wide area network (WAN), and/or other content and data to control circuitry 911, which may include processing circuitry, and storage 914. Control circuitry 911 may be used to send and receive commands, requests, and other suitable data using I/O path 912, which may comprise I/O circuitry. I/O path 912 may connect control circuitry 911 (and specifically control circuitry) to one or more communications paths.

Control circuitry 911 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 911 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 911 executes instructions for an emulation system application stored in memory (e.g., the storage 914). Memory may be an electronic storage device provided as storage 914 that is part of control circuitry 911.

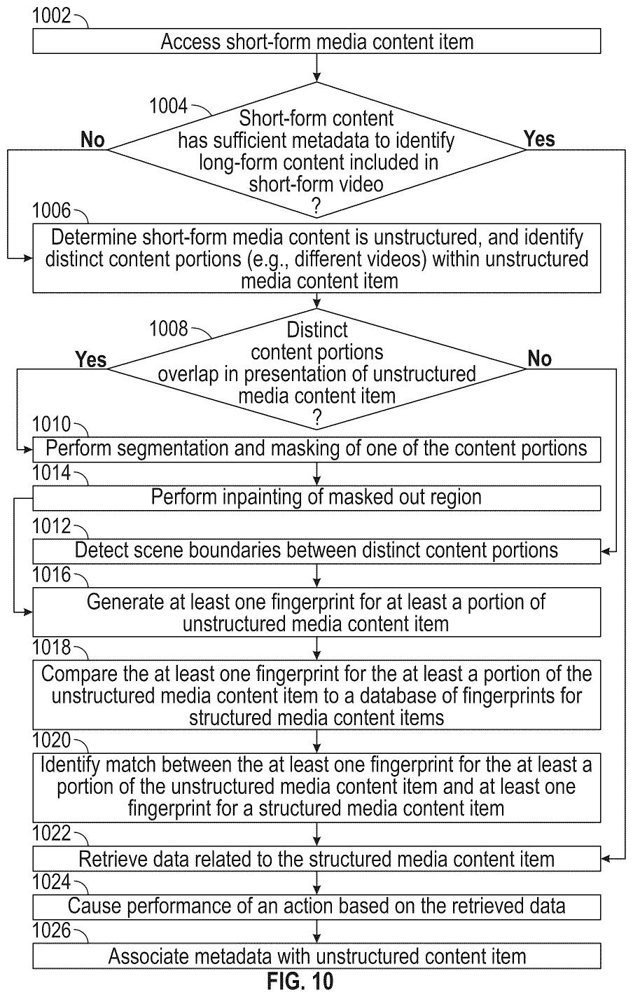

FIG. 10 is a flowchart of a detailed illustrative process 1000 for identifying a structured media content item corresponding to at least a portion of an unstructured media content item, in accordance with some embodiments of this disclosure. In various embodiments, the individual steps of process 1000 may be implemented by one or more components of the devices, methods, and systems of FIGS. 1-9 and may be performed in combination with any of the other processes and aspects described herein. Although the present disclosure may describe certain steps of process 1000 (and of other processes described herein) as being implemented by certain components of the devices, methods, and systems of FIGS. 1-9, this is for purposes of illustration only, and it should be understood that other components of the devices, methods, and systems of FIGS. 1-9 may implement those steps instead.

At 1002, control circuitry (e.g., control circuitry 804 of FIG. 8 and/or control circuitry 911 of FIG. 9) and/or I/O circuitry (e.g., 802 of FIG. 8 and/or 912 of FIG. 9), may access a short-form media content item (e.g., unstructured media content item 110 of FIG. 1). For example, unstructured media content item 110 may be posted to (or may be requested to be posted to) a social network post (e.g., social network post 111 of FIG. 1) or provided on another platform. In some embodiments, at 1002, a user may request access to the unstructured media content item, e.g., on the social media platform, or may request additional information (and/or that one or more actions be taken) related to the unstructured content (e.g., select an option requesting such information, or otherwise providing input, such as, for example, “What movie is that clip of in this video short?” In some embodiments, all posts to a social media platform may be subjected to the processing of FIG. 10 prior to the social media post being posted to the platform. In some embodiments, a short-form content platform 104 may receive inputs from a user (e.g., the user indicated at 117 of FIG. 1) to create and upload the short-form content to the social media platform or any other suitable platform.

At 1004, the control circuitry may determine whether the short-form content has sufficient metadata to identify long-form content included in the short-form content item. For example, if the control circuitry determines that metadata displayed in or embedded in the social media post and/or short-form content indicates a title of the long-form content item (e.g., the movie “Cars”), a portion of which may be in the short-form content, processing may proceed to 1022. Otherwise, if the control circuitry determines such metadata is not included nor embedded in the short-form content item, processing may proceed to 1006.

At 1006, based on the negative determination at 1004, the control circuitry may determine that the short-form content is unstructured, e.g., has minimal metadata that is insufficient to identify, e.g., a title of a movie or an actor, in a clip of long-form content included in the short-form content. The control circuitry may identify distinct content portions, e.g., portion 113 and 115 of FIG. 1 of unstructured media content item 110. For example, the control circuitry may determine (e.g., using image processing techniques) that one content portion (e.g., 113) in is the foreground and another content portion (e.g., 115) is in the background, or that a display area of one content portion otherwise overlaps a display area of another content portion, or may determine that a scene (e.g., scene 304 of FIG. 3) is substantially different than another scene (e.g., 306 of FIG. 3) within the unstructured media content item, and thus that these scenes likely constitute different content portions of the unstructured media content item. In some embodiments, a machine learning model may be trained to differentiate multiple portions of content, e.g., trained to recognize content often spliced with long-form content, such as, for example, a meme or a video of a user reacting to the long-form content, and distinguish such content from the long-form content. In some embodiments, the distinct content portions are identified based on computer-implemented techniques to identify salient portions of the short-form content.

At 1008, the control circuitry may determine whether the identified distinct content portions overlap (or occlude) in the presentation of the unstructured media content item (e.g., the presentation of portion 113 overlapping a region of portion 115 in FIG. 1) or if such distinct content portions are shown at distinct times (e.g., in FIG. 3, scene 304 being shown at a different time than scenes 306 and 308). For example, the control circuitry may determine that the at least a portion of the unstructured media content item comprises a first video (e.g., portion 113 of an influencer reacting to a clip of the movie “Cars”) being simultaneously played at the same time as a second video (e.g., portion 115, a clip of the movie “Cars”) within the unstructured media content item, as part of the social network post. Alternatively, the control circuitry may determine that the first and second videos are played at different times within the unstructured media content item. If overlap is identified, processing may proceed to 1010; otherwise processing may proceed to 1012.

At 1010, the control circuitry may modify the unstructured media content item by performing segmentation and masking (e.g., as shown at 112 of FIG. 1), to extract a portion of the unstructured media content item (e.g., portion 113). Any suitable computer-implemented image segmentation technique may be used, as discussed in relation to FIG. 1. At 1014, the control circuitry may perform inpainting to fill in an empty region left in the modified unstructured media content item as a consequence of the segmentation and masking. At 1012, the control circuitry may employ any suitable boundary detection technique to determine that a boundary between a first portion of the unstructured media content (e.g., scene 304 of FIG. 3, which may be a meme spliced in by a content creator) and a second portion of the unstructured media content (e.g., scenes 306 and 308 of FIG. 3).

At 1016, the control circuitry may generate at least one fingerprint for at least a portion of the unstructured media content item. For example, the control circuitry may generate a fingerprint for each of extracted portion 113 and modified unstructured media content item 114 (e.g., having had portion 113 segmented out, and having had a region previously corresponding to portion 113 inpainted). As another example, a fingerprint may be generated for scenes 306 and/or 308 of FIG. 3, and scene 304. In some embodiments, fingerprints may not be generated for, e.g., portion 113 or scene 304 determined as not likely to correspond to a clip of long-form content. In some embodiments, the generated fingerprint may be based on audio, images, videos, text, or any suitable combination thereof, of the unstructured media content item.

At 1018, the control circuitry may compare the at least one fingerprint for the at least a portion of the unstructured media content item and at least one fingerprint for a structured media content item. For example, a fingerprint for one or more scenes of the movie “Cars,” stored in database 122, may be determined to match the at least one fingerprint obtained at 118 of FIG. 1 for the unstructured media content item, at 1020. In some embodiments, each of the fingerprints, e.g., for the clip of the long-form content and the user-generated portion (e.g., a meme or influencer reaction) may be compared to the fingerprint database, to confirm which of the portions is the long-form content clip. At 1022, the control circuitry may retrieve data related to the structured media content item. Such data may be any suitable data related to the structured media content item, such as data for an advertisement; data for a trailer; or data to enable providing for display, to the user having accessed the unstructured media content, options to view, record, set a reminder for, rent, purchase, subscribe to a new platform or content source or channel, disambiguate a future query based on the context of the associated metadata, or perform any other suitable action in relation to the structured media content item. At 1024, the control circuitry may cause performance of an action based on the data retrieved at 1022. For example, an account or profile of the user, having accessed the short-form media content item, may be associated with or linked with an account or profile of the user with a long-form content platform, and the user may be redirected to such long-form platform, which may provide an option to consume, record, store, set a reminder for, or perform any other suitable action in relation to the long-form content (e.g., the movie “Cars”) identifying as a match at 1020. In some embodiments, a selectable option may be presented at the short-form content platform (e.g., option 222 of FIG. 2) to trigger performance of actions in relation to the identified long-form media content item.

In some embodiments, the distinct content portions are identified based on computer-implemented techniques to identify salient portions of the short-form content. In some embodiments, whether a portion is salient may be based on a popularity of a scene, e.g., “You can't handle the truth” from the movie “A Few Good Men,” may be considered an iconic scene based on a number of appearances of references to the scene in, for example, a database or Internet searches. In some embodiments, the plurality of structured media content items at database 122 comprise at least one movie or television show, and the plurality of fingerprints stored in the database comprise fingerprints for portions of the at least one movie or television show having at least a threshold level of popularity and do not comprise fingerprints for portions of the at least one movie or television show not having at least a threshold level of popularity.

At 1026, the control circuitry may associate metadata (e.g., based on the retrieved data at 1022, such as, for example, a title of the movie “Cars”) with the unstructured media content item (e.g., 110 of FIG. 1). Thus, for future inputs from the same user on the short-form content platform, or another user on the short-form content platform, in relation to the unstructured media content item accessed at 1002, the unstructured media content item may now be considered a structured media content item with which sufficient metadata is already associated, to perform the actions indicated at 1024, without having to perform the regenerating and comparing of fingerprints.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A computer-implemented method comprising:
accessing an unstructured media content item;
generating a first fingerprint for at least a portion of the unstructured media content item;
accessing a database storing a plurality of fingerprints, each of the plurality of fingerprints corresponding to at least a portion of a respective structured media content item of a plurality of structured media content items;
determining that the first fingerprint corresponds to a second fingerprint from the plurality of fingerprints stored at the database;
identifying a structured media content item from the plurality of structured media content items that corresponds to the second fingerprint;
retrieving data related to the structured media content item; and
causing performance of an action based on the retrieved data.

2. The method of claim 1, wherein the unstructured media content item is uploaded to a social network platform as a social network post, based on input received from a first user of the social network platform.

3. The method of claim 2, wherein the unstructured media content item is accessed, and the first fingerprint is generated, based at least in part on receiving an input from a second user of the social network platform to access the unstructured media content item.

4. The method of claim 2, wherein the first fingerprint is generated based at least in part on receiving an input from a second user of the social network platform requesting that one or more actions be taken regarding the structured media content item that corresponds to the unstructured media content item.

5. The method of claim 2, further comprising:
based on identifying the structured media content item from the plurality of structured media content items that corresponds to the second fingerprint, associating metadata related to the retrieved data with the unstructured media content item prior to receiving input from a second user of the social network platform to access the unstructured media content item.

6. The method of claim 2, further comprising:
determining the at least a portion of the unstructured media content item comprises a first video being simultaneously played with a second video, as part of the social network post;
wherein generating the first fingerprint is based on the first video and is not based on the second video.

7. The method of claim 6, wherein the second video overlaps and is played simultaneously with a portion of the first video, or the second video is played at a different time than the first video within the unstructured media content item and does not overlap a portion of the first video.

8. The method of claim 6, wherein the first video comprises a background of the unstructured media content item, and the second video comprises a foreground of the unstructured media content item.

9. The method of claim 6, wherein the second video area comprises an object occluding the first video, and the method further comprises:
determining that the first video is associated with a salience value above a threshold;
modifying the at least a portion of the unstructured media content item by:
segmenting and masking out the second video including the object; and
performing in-painting at a portion of the first video previously occluded by the second video comprising the object; and
generating the first fingerprint based on the modified at least a portion of the unstructured media content item comprising the salient first video having the in-painted portion.

10. The method of claim 9, wherein the object is a depiction of the first user of the social network platform.

11. The method of claim 2, wherein causing performance of the action comprises causing the social network platform to output an advertisement for the structured media content item, based on the retrieved data.

12. The method of claim 1, wherein causing performance of the action comprises:
redirecting a user from a social network platform, at which the unstructured media content item is accessed by the user, to a second content platform which performs the action based on the retrieved data, wherein the user is associated with a user profile with the second content platform that is linked to a user profile of the user with the social network platform.

13. The method of claim 12, wherein causing performance of the action further comprises providing, based on the retrieved data, a selectable option to access the structured media content item, and wherein the redirecting is performed in response to receiving selection of the selectable option.

14. The method of claim 1, further comprising:
determining that a user of a social network platform, at which the unstructured media content item is accessed by the user, is accessing a second content platform; and
providing a reply to a query received from the user via the second content platform, wherein the query is disambiguated based at least in part on the retrieved data, and wherein the retrieved data comprises metadata that is associated with the unstructured media content item based on the first fingerprint and the second fingerprint.

15. The method of claim 1, wherein, prior to generating the first fingerprint, the unstructured media content item is not associated with metadata identifying a title of a structured media content item that comprises the at least a portion of the unstructured media content item.

16. The method of claim 1, wherein causing performance of the action comprises generating for display, based on the retrieved data, a recommendation to play the structured media content item or store the structured media content item.

17. The method of claim 16, further comprising:
determining that that a user of a social network platform, at which the unstructured media content item is accessed by the user, is not subscribed to a second content platform enabling access to the structured media content item; and
wherein causing performance of the action comprises generating for display, based on the retrieved data, an option to enable the user to subscribe to the second content platform to access the structured media content item.

18. The method of claim 1, wherein the plurality of structured media content items comprises at least one movie or television show, and the plurality of fingerprints stored in the database comprise fingerprints for portions of the at least one movie or television show having at least a threshold level of popularity and do not comprise fingerprints for portions of the at least one movie or television show not having at least the threshold level of popularity.

19. A system comprising:
control circuitry configured to:
access an unstructured media content item;
generate a first fingerprint for at least a portion of the unstructured media content item;
access a database storing a plurality of fingerprints, each of the plurality of fingerprints corresponding to at least a portion of a respective structured media content item of a plurality of structured media content items;
determine that the first fingerprint corresponds to a second fingerprint from the plurality of fingerprints stored at the database;
identify a structured media content item from the plurality of structured media content items that corresponds to the second fingerprint;
retrieve data related to the structured media content item; and
cause performance of an action based on the retrieved data.

20. The system of claim 19, wherein the unstructured media content item is uploaded to a social network platform as a social network post, based on input received from a first user of the social network platform.

21-90. (canceled)
